(19) United States
(12) Patent Application Publication
(10) Pub. No.: US 2015/0047472 A1
(43) Pub. Date: Feb. 19, 2015

(54) Dual-drive, self-ratcheting, mechanism with multiple input ports

(71) Applicant: Leon Robert Palmer, Somerset, MA (US)

(72) Inventor: Leon Robert Palmer, Somerset, MA (US)

(21) Appl. No.: 13/987,640

(22) Filed: Aug. 19, 2013

(51) Int. Cl. B25B 15/04; B25B 13/46; B25B 17/00

(52) U.S. Cl. CPC B25B 15/04; B25B 17/00; B25B 13/46
USPC 81/63.1

(57) ABSTRACT

The invention is a dual-drive, self-ratcheting multiple input ports mechanism, that converts oscillatory motion applied to its input, to unidirectional axial rotation motion at its output and is able to be switched to produce solely clockwise rotation at its output, regardless of the direction of rotation applied to the input and is able to be switched to produce solely counterclockwise rotation at its output, regardless of the direction of rotation applied to the input and is provided with a detachable input handle, that can be coupled to said multiple input ports.

### FIELD OF THE INVENTION

This invention relates to mechanical drive systems and more particularly to those in which the output rotation can be solely clockwise, regardless of the direction of the input rotation and the output rotation can be solely counterclockwise, regardless of the direction of the input rotation. The direction of output rotation, from an oscillatory input, is selective within the same embodiment. The mechanism can be described as devices such as, but not limited to, a mechanical converter, a mechanical rectifier and a converter of oscillatory input motion to unidirectional rotational output motion. In order for its advantages to be appreciated, the mechanism must be embodied into an application. The selected exemplification from numerous applications, is a ratcheting screwdriver.

### BACKGROUND OF THE INVENTION

This invention, a dual-drive, self-ratcheting mechanism, has numerous applications in consumer, medical and industrial products, while, a ratcheting screwdriver is the preferred item to serve as the exemplification of the advantages, that the mechanism provides. Conventional ratcheting screwdrivers, employ a single ratcheting mechanism, that is required to be intermittently-ratcheted between drives and therefore only ready-to- drive hardware 50% of the time, while the remaining 50% is time and effort, that is unproductively spent, ratcheting-up. Hence, a screwdriver, mechanized with a conventional single-ratcheting mechanism, is only 50% efficient. Whereas, a screwdriver, mechanized with the self-ratcheting system, eliminates the user's need to waste time and effort ratcheting between drives. The ratcheting occurs automatically within the mechanism, as reciprocating input-motion is applied, while the screwdriver is being operated.

The dual-drive self-ratcheting mechanism is comprised of driving elements, such as, but not limited to, a pair of a ratchet wheels and pawls, or a plurality of one-way roller-type clutches, or a plurality of two-way roller-type clutches. Solely for exemplification and simplicity, the included illustrations depict a proposed assembly procedure of a dual-drive self-ratcheting mechanism, that employs roller-type clutches.

### BRIEF SUMMARY OF THE INVENTION

The invention is a mechanism, that converts oscillatory motion applied to its input, into unidirectional axial rotation at its output. The mechanism can be set to produce solely clockwise rotation at its output, regardless of the direction of rotation of the input and can be set to produce solely counterclockwise rotation at its output, regardless of the direction of rotation of the input. The mechanism must be embodied into a product, in order for its advantages to be useful.

Even though the mechanism has numerous applications, the manually-operated ratchet screwdriver is selected, not as the invention, but, as an ideal exemplification of an application.

One objective of this exemplification, is to create a manually-operated, dual-drive self-ratcheting screwdriver hand tool, that ratchets-up automatically during use, thereby eliminating the user's need to perform the unproductive ratcheting-up motion, between each productive drive.

Another objective, is to create a manually-operated, self-ratcheting dual-drive self-ratcheting screwdriver hand tool, that is operated single-handedly, thereby enabling fastening hardware, to be held in place, with user's opposite hand.

Another objective is to provide a manually-operated self-ratcheting dual-drive self-ratcheting screwdriver hand tool, whereby resistance-to-backwards-rotation, from the screw during its installation into a material, to enable ratcheting-up, is no longer necessary.

Another objective is to create a manually-operated, dual-drive self-ratcheting screwdriver, whereby the self- ratcheting mechanism is operated via the clockwise and counterclockwise axial turning of an input handle, that can be coupled to the reversing mechanism to operate the dual-drive self-ratcheting mechanism, or, can be coupled to a driving element to operate the dual-drive self-ratcheting, as well as radially swung for increased leverage for applying finishing-torque and breaking the finishing torque and loosen fastening hardware.

### BRIEF DESCRIPTION OF THE DRAWINGS

FIG. 1 through FIG. 53 illustrate a suggested step-by-step procedure, for assembling the elements of a self-ratcheting, double-drive mechanism, that converts oscillatory motion applied to an input, into unidirectional rotation motion at the output for clockwise and counterclockwise direction.

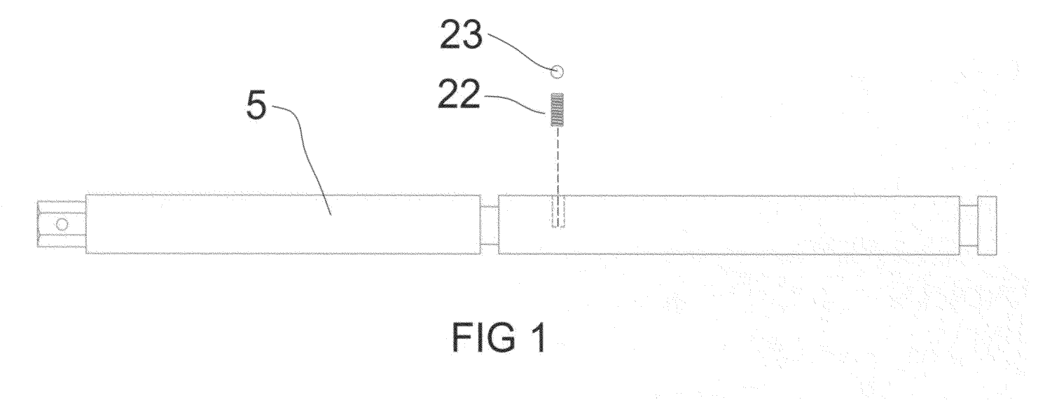

Note: FIG. 41 is used to identify each component numerically, for the following suggested assembly procedure.

FIG. 1: Spring 22 is prepared to be placed into opening provided in Driveshaft 5. Ball 23 is prepared to be placed onto Spring 22.

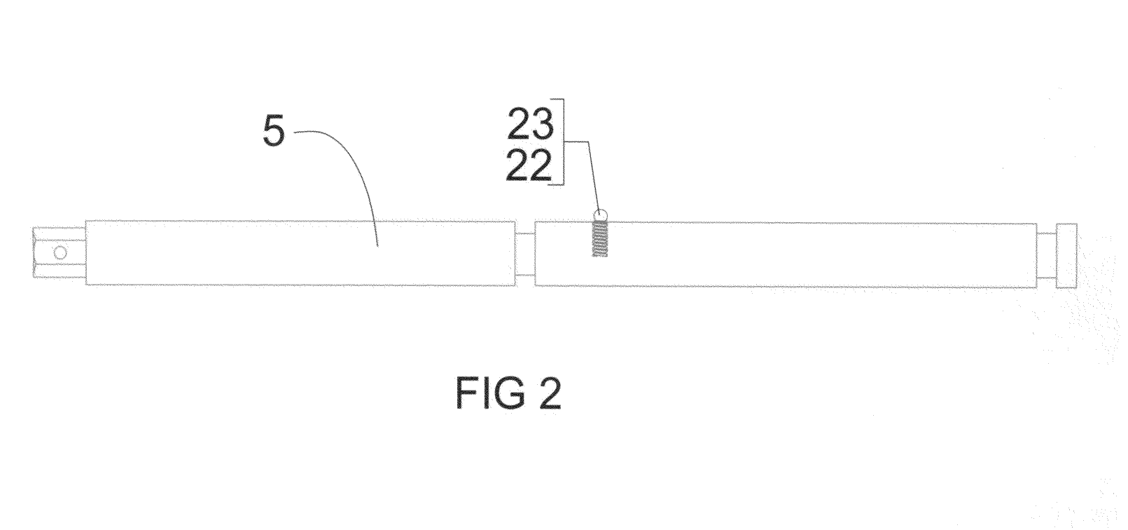

FIG. 2 Spring 22 is placed into opening provided in Driveshaft 5. Ball 23 is placed onto Spring 22.

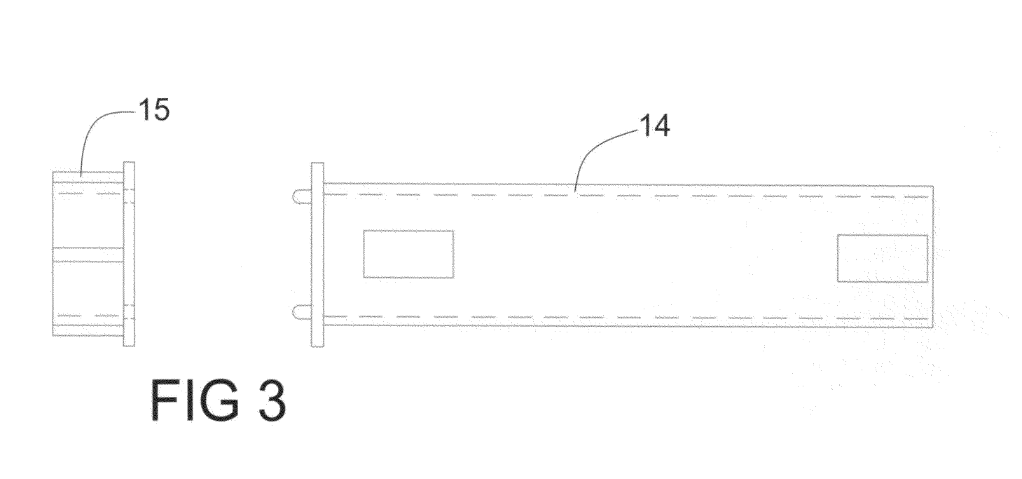

FIG. 3: A two-dimensional illustration; Clutching Element Housing 14 and Switch Element 15 are prepared to be keyed together. Switch Element 15 is provided with a plurality of keys, that mate with channels provided in Clutching Element Housing 14.

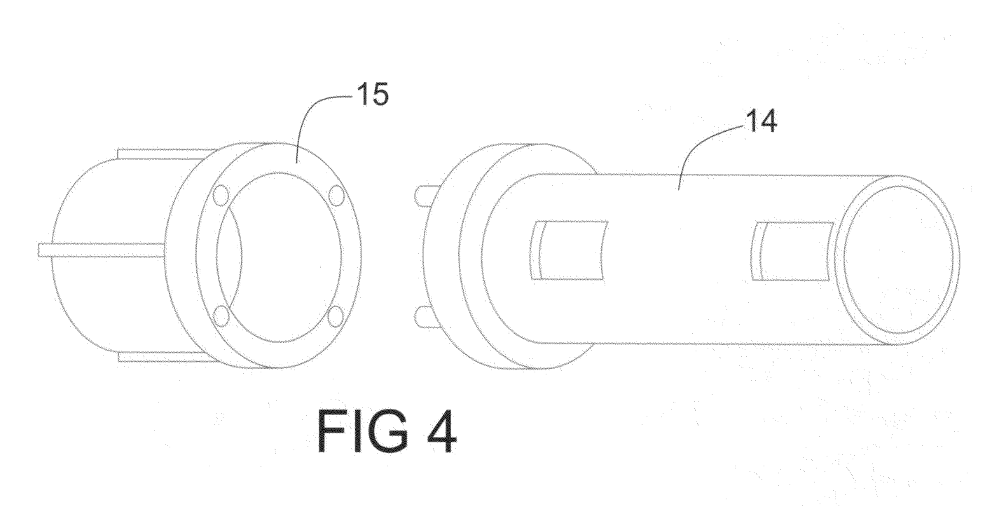

FIG. 4: A three-dimensional illustration; Clutching Element Housing 14 and Switch Element 15 are prepared to be keyed together. Switch Element 15 is provided with a plurality of keys, that mate with channels provided in Clutching Element Housing 14.

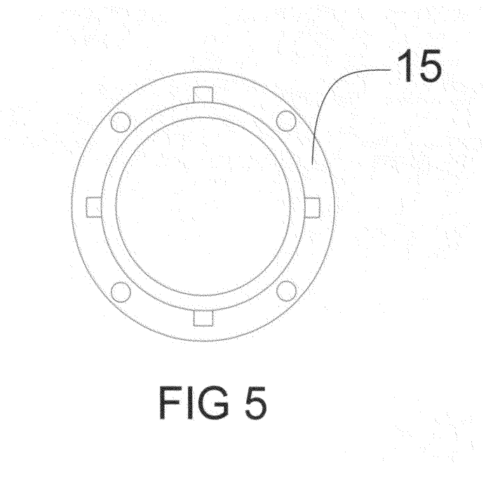

FIG. 5: Posterior view of Switch Element 15.

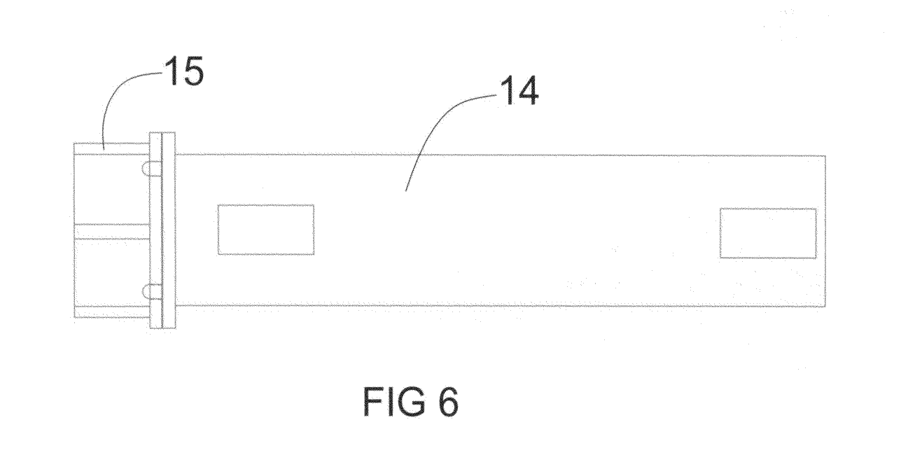

FIG. 6: Two-dimensional illustration of Clutching Element Housing 14 and Switch Element 15 keyed together.

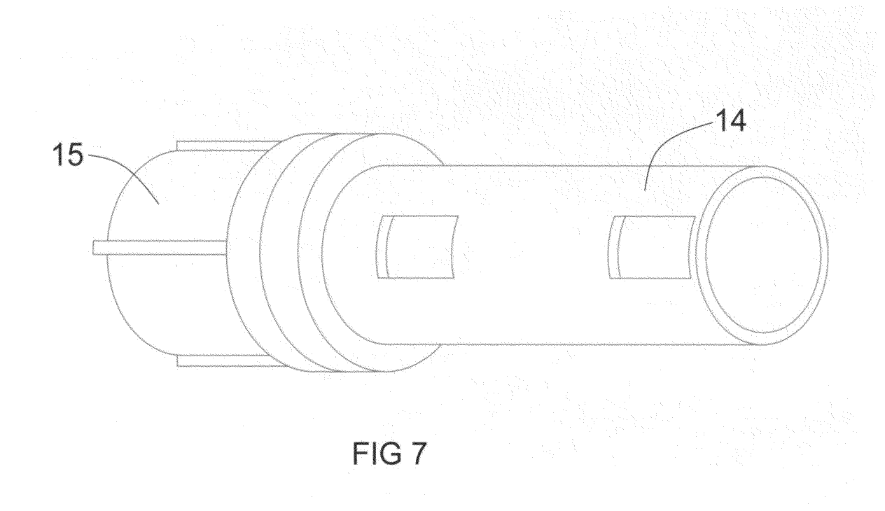

FIG. 7: Three-dimensional illustration of Clutching Element Housing 14 and Switch Element 15 keyed together

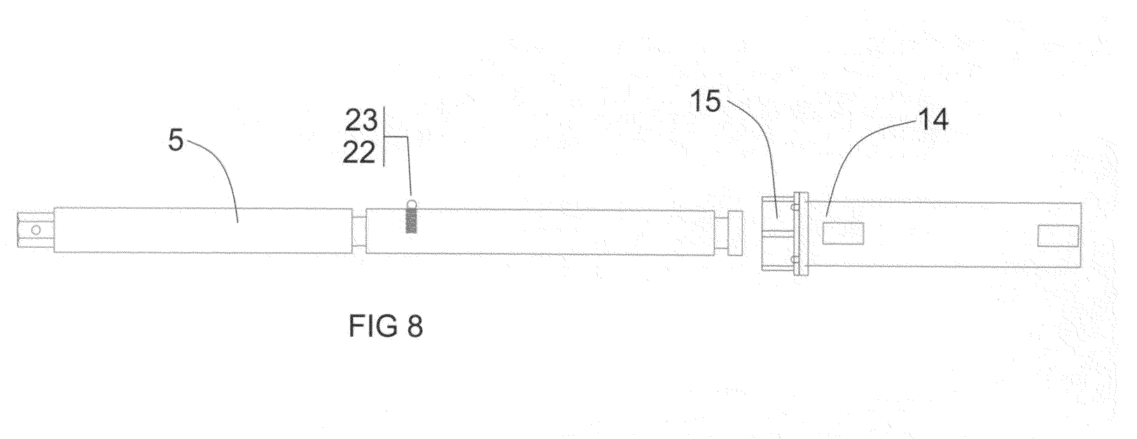

FIG. 8: Clutching Element Housing 14 and Switch Element 15 are prepared to be slid onto Driveshaft 5 and over spring-loaded Ball 23.

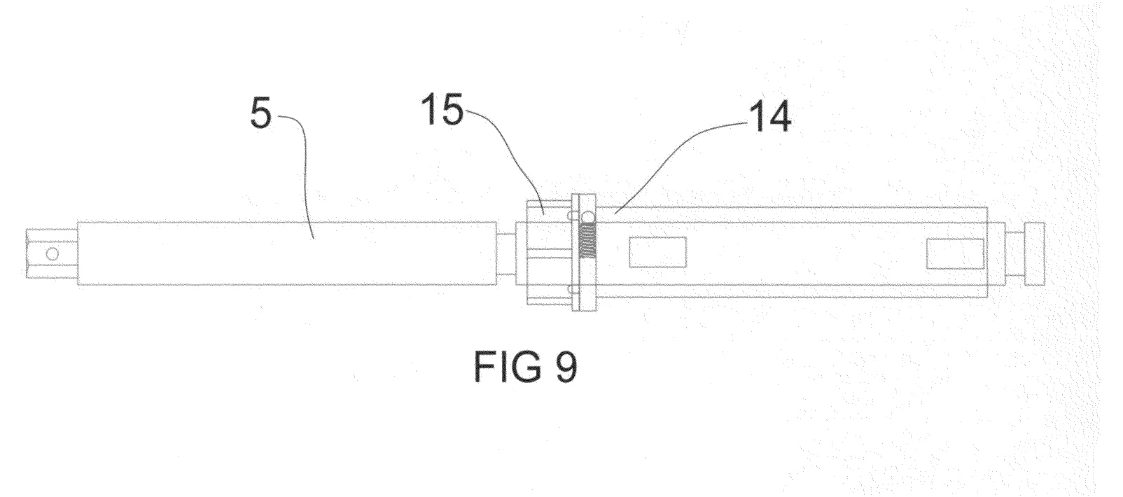

FIG. 9: Clutching Element Housing 14 and Switch Element 15 are slid onto Driveshaft 5 and over spring-loaded Ball 23

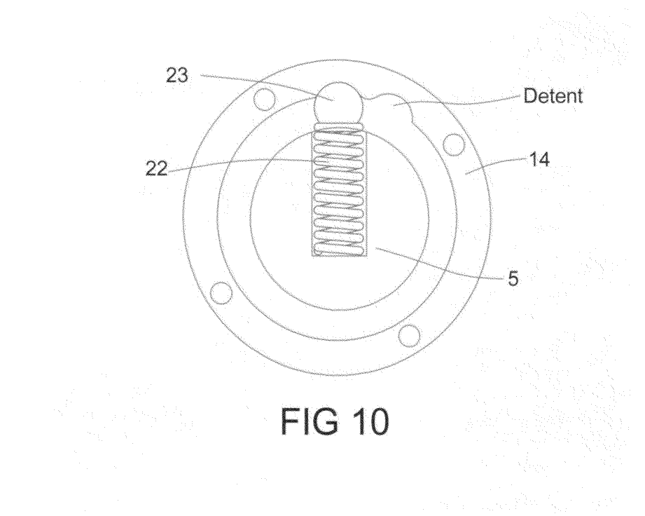

FIG. 10: Spring-loaded Ball 23 is shown captured in recessed detent provided in flange of Clutch Housing 14, to retain Switch Element 15 and Clutch Housing 14 in position, to cause Driveshaft 5 to rotate axially in only clockwise direction.

FIG. 11: Spring-loaded Ball 23 is shown captured in opposite detent provided in flange of Clutch Housing 14, to retain Switch Element 15 and Clutch Housing 14 in position, to cause Driveshaft 5 to rotate axially in only counterclockwise direction.

FIG. 12: Three-dimensional illustration of channeled detail of Anterior Housing 13 prepared to be slid onto Drive Shaft 5 and keyed to Switch Element 15.

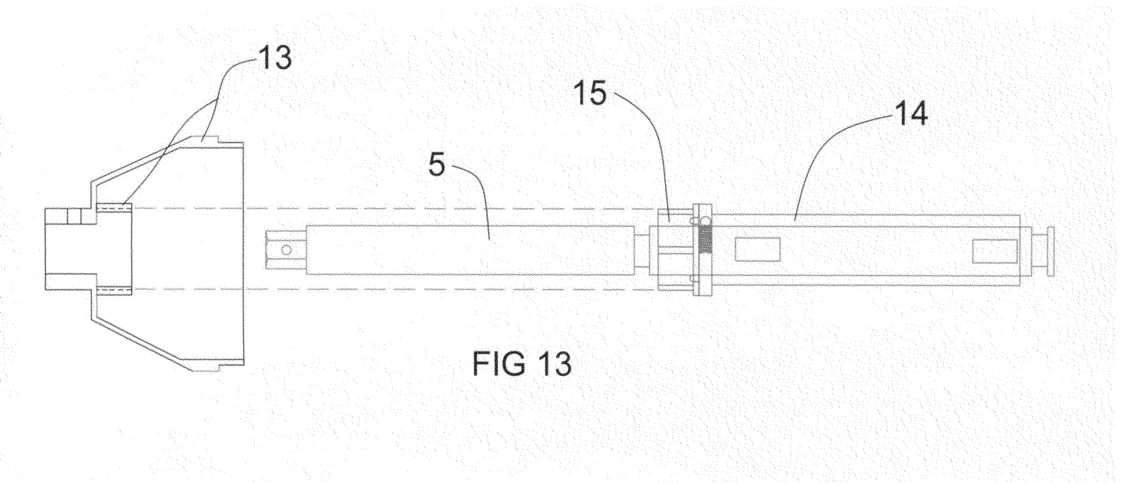

FIG. 13: Dashed lines show the alignment of the keys of Switch Element 15, with the channels of Anterior Housing 13.

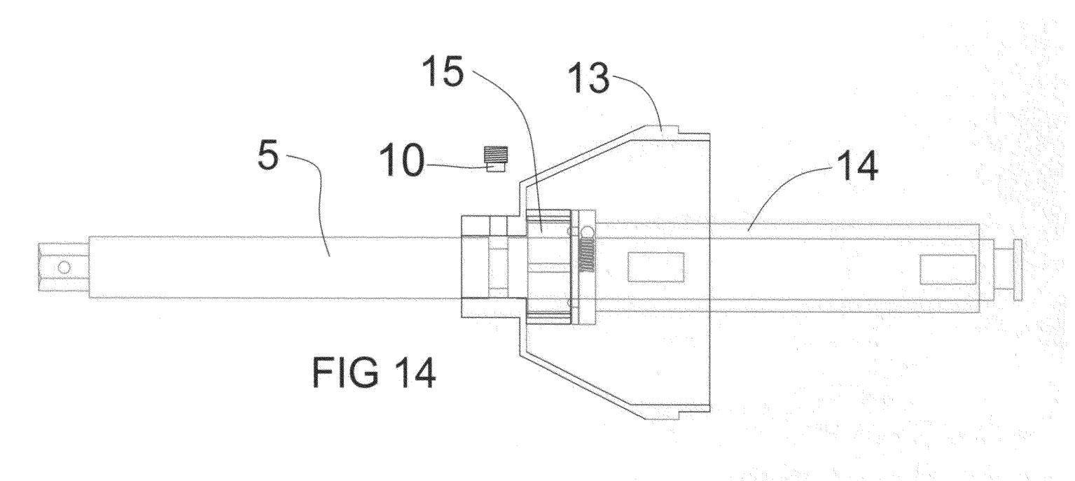

FIG. 14: Anterior Housing 13 is slid into onto Drive Shaft 5 and keyed to Switch Element 15. Retaining Element 10 is prepared to be installed into groove provided in Driveshaft 5.

FIG. 15: Retaining Element 10 is installed to retain Anterior Housing 13 in place on Driveshaft 5. Clutching Components 11 are prepared for being inserted into their respective slots provided in Clutching Element Housing 14.

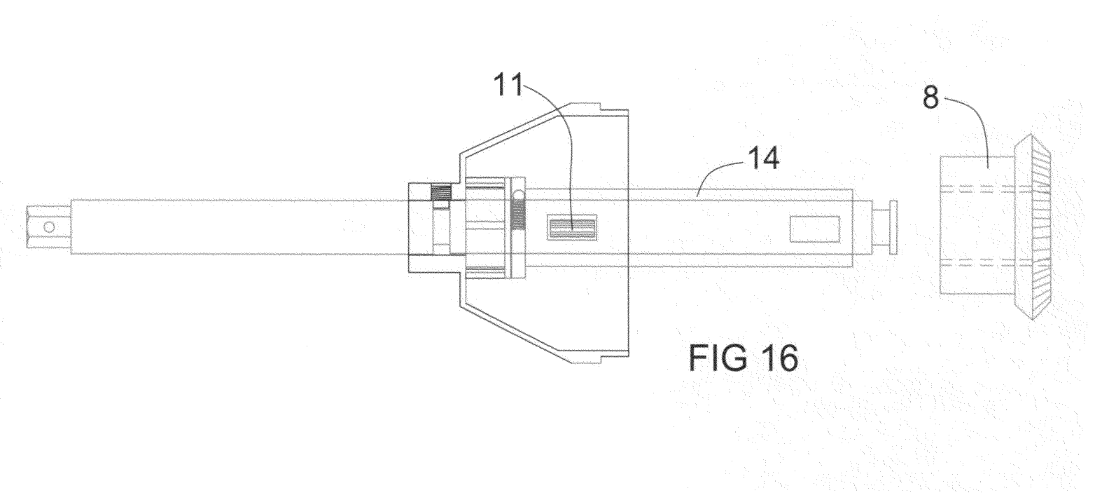

FIG. 16: Clutching Components 11 are inserted into their respective slots provided in Clutching Element Housing 14. Driving Element 8 is prepared for being slid onto Clutching Element Components 11.

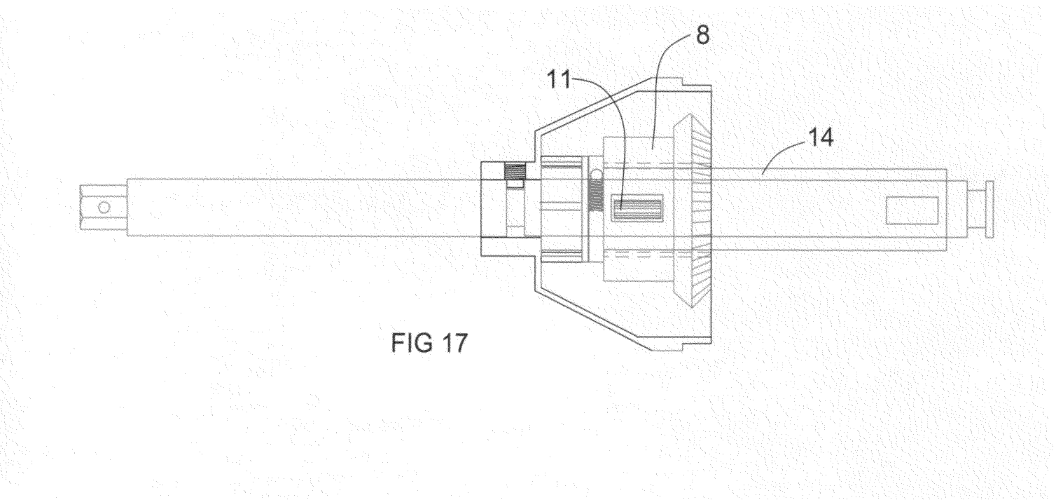

FIG. 17: Driving Element 8 is slid onto Clutching Element Components 11.

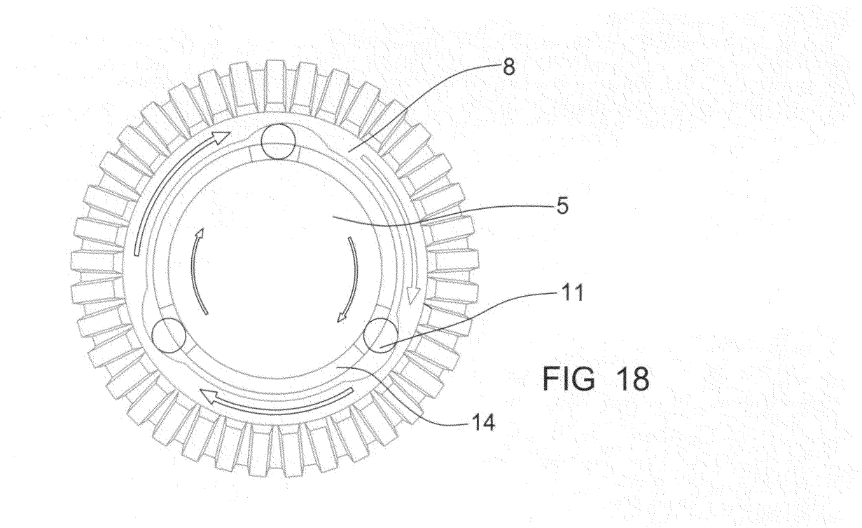

FIG. 18: Driving Element 8 is rotated clockwise; Clutch Element Components 11 become wedged between ramp surface and Driveshaft 5 surface; Driveshaft 5 is entrained to rotate axially only in clockwise direction.

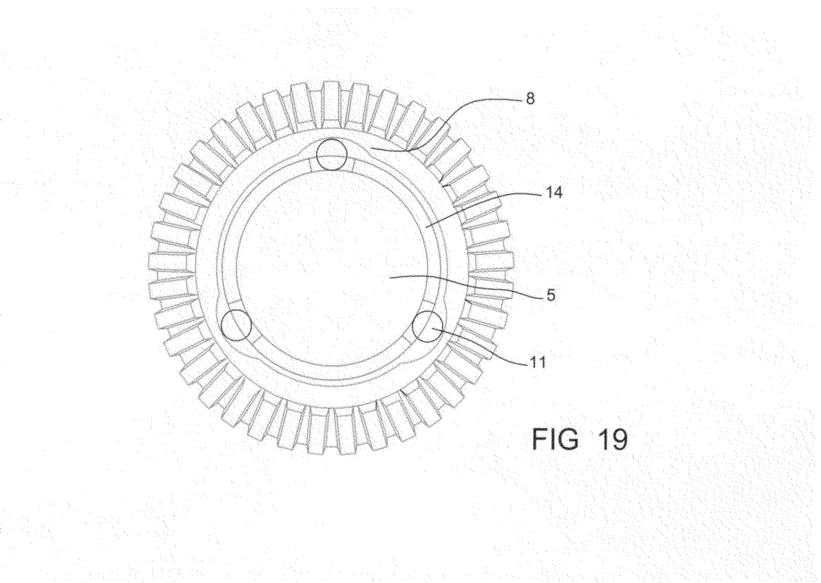

FIG. 19: Driving Element 8 is in override mode whereby, Clutch Element Components 11 are not wedged between ramp surface and Driveshaft surface, thereby override Driveshaft surface 5.

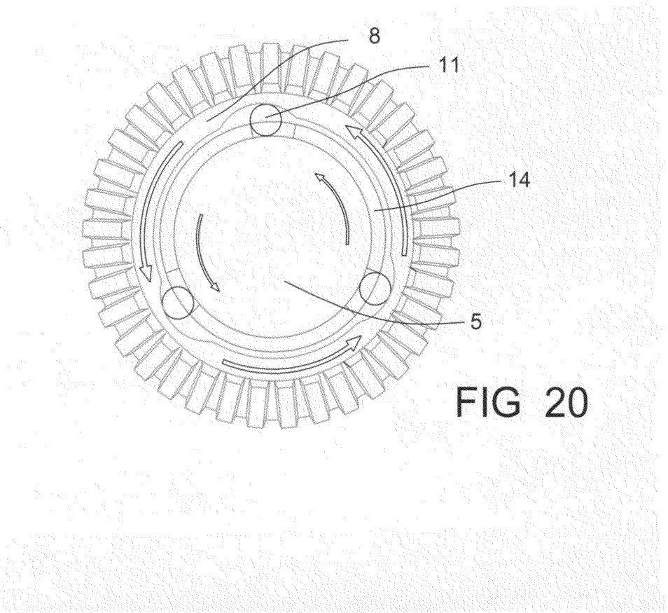

FIG. 20: Driving Element is rotated counterclockwise; Clutch Element Components 11 become wedged between ramp surface and Driveshaft 5 surface; Driveshaft 5 is entrained to rotate axially only in counter-clockwise direction.

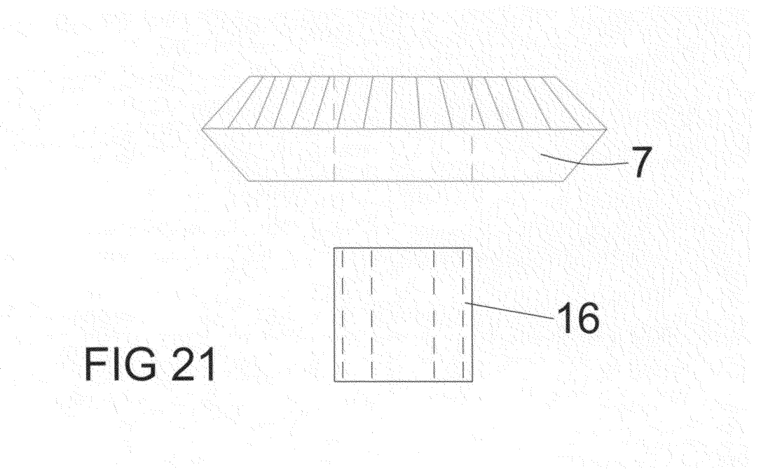

Note: FIG. 21 through FIG. 28 describe a suggested procedure for the Reversing Mechanism Assembly

FIG. 21: Second Input Receptacle Insert 16, is prepared to be coupled to First Rotating Element 7

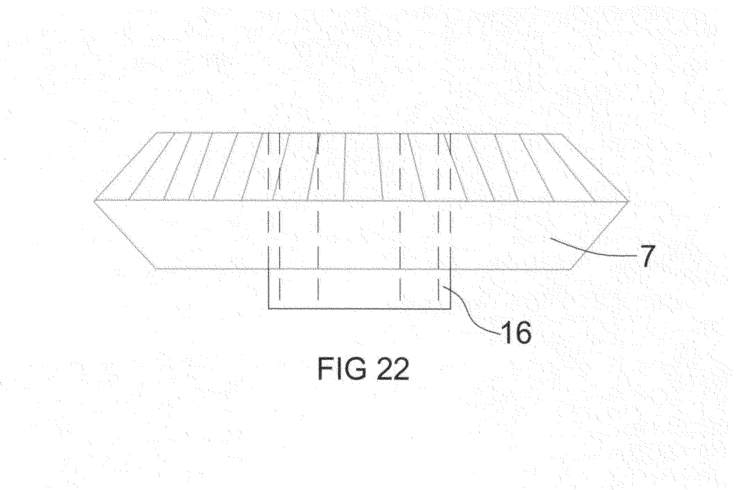

FIG. 22: Second Input Receptacle Insert 16 is coupled to First Rotating Element 7.

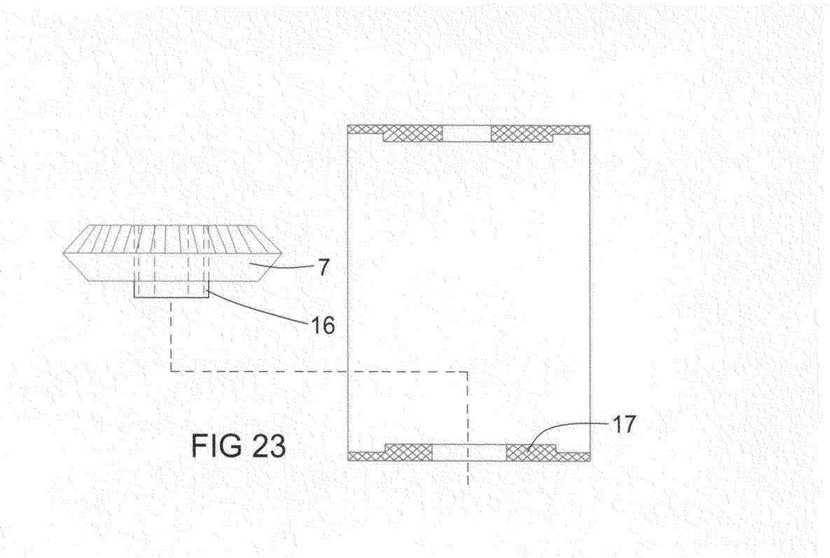

FIG. 23: The assembly of Second Input Receptacle Insert 16 and First Rotating Element 7 of FIG. 9, is prepared to be inserted into a through-hole of Reversing Mechanism Housing 17.

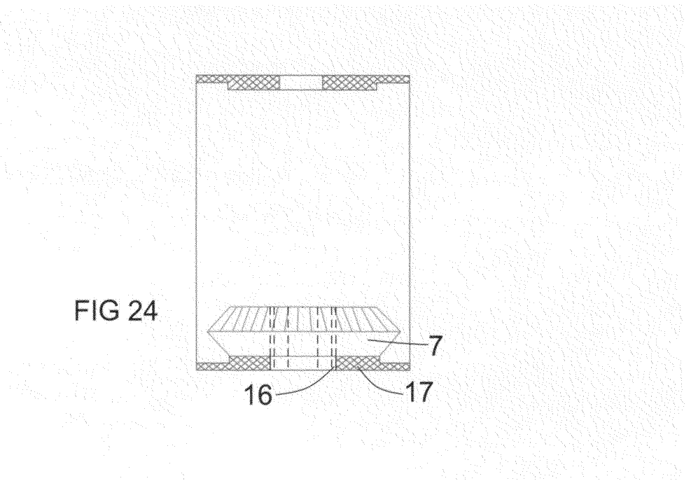

FIG. 24: The assembly of Second Input Receptacle Insert 16 and First Rotating Element 7 of FIG. 9, is inserted into a through-hole of Reversing Mechanism Housing 17 for rotating freely.

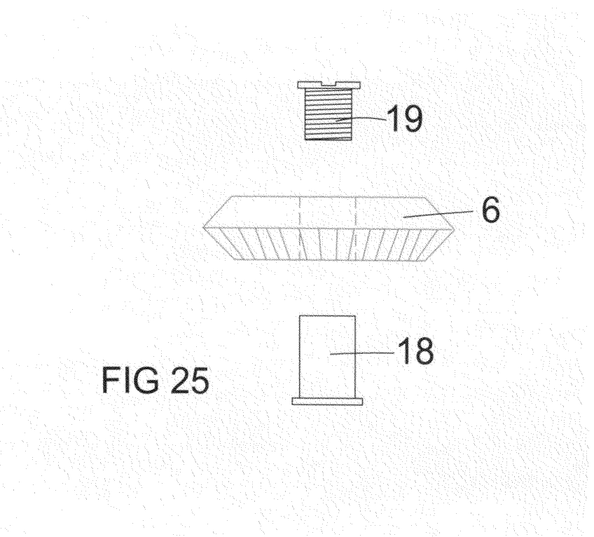

FIG. 25: Exploded view of the Second Rotating Element 6 of the Reversing Mechanism and a two-piece axle comprised of First Axle Component 18 and Second Axle Component 19.

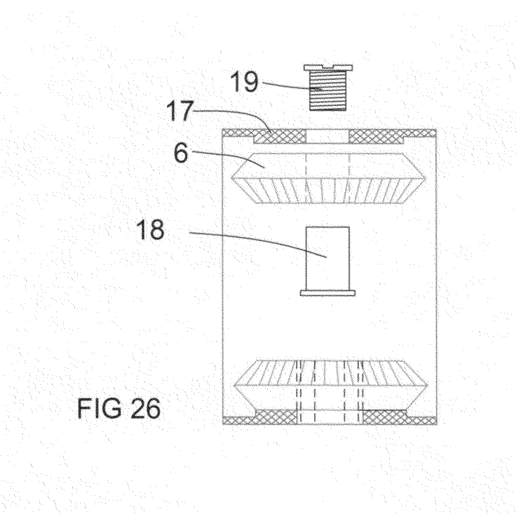

FIG. 26: The Second Rotating Element 6 of the Reversing Mechanism is prepared to be rotatably attached to the Reversing Mechanism Housing 17, by the fastening together of First Axle Component 18 and Second Axle Component 19 through the bore of Second Rotating Element 6.

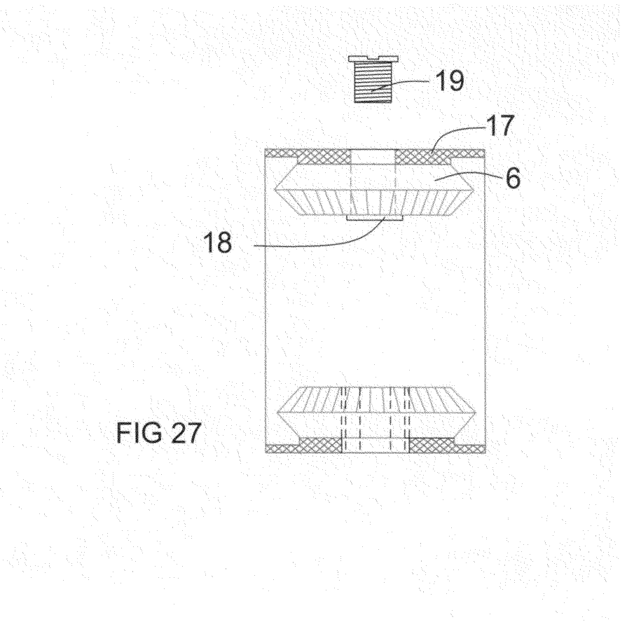

FIG. 27: The First Axle Component 19 of the Two-Piece Axle is inserted into bore of Second Rotating Element 6, while the Second Axle Component 19 of the Two-Piece Axle is prepared to be fastened to the First Axle Component 18.

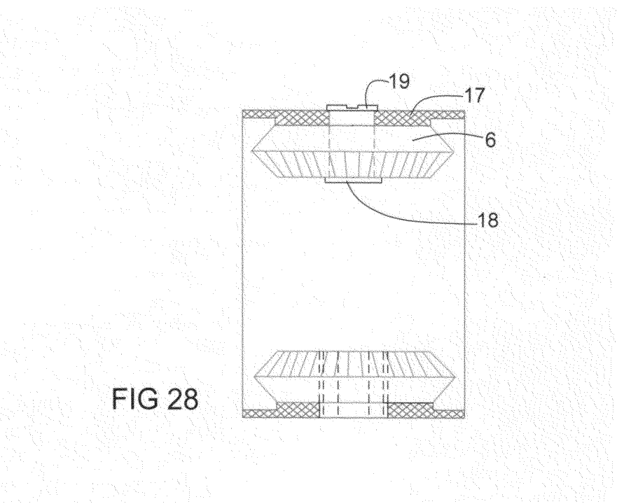

FIG. 28: The Second Axle Component 19 of the Two-Piece Axle is fastened to the First Axle Component 18, thereby forming a complete Axle, about which the Second Rotating Element 6 rotates.

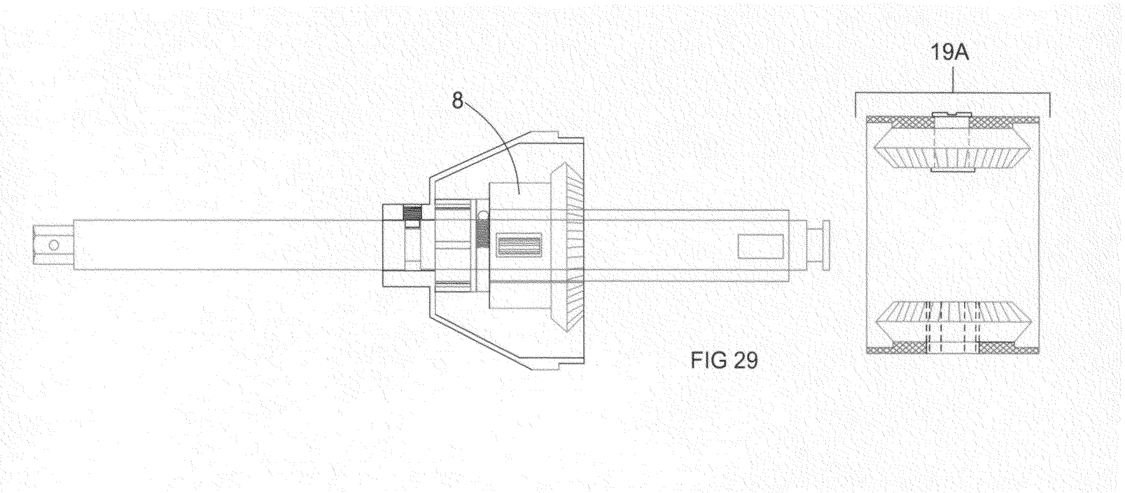

FIG. 29: Reversing Mechanism Assembly 19A, is prepared for being positioned, to mesh with the Second Driving Element 8.

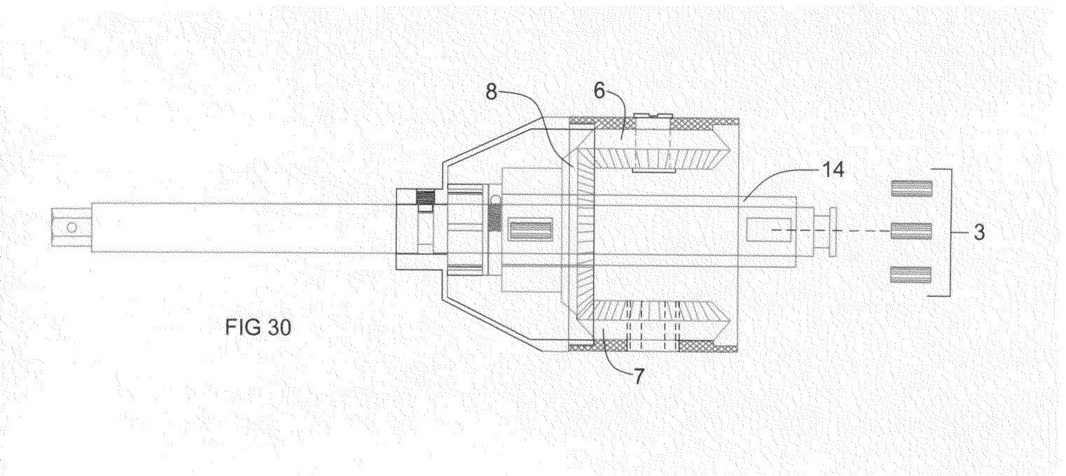

FIG. 30: Reversing Mechanism 19A is in place, with its First Rotating Element 6 and Second Rotating Element 7, meshing with the Second Driving Element 8. Components 3 of the Clutching Element, are prepared for installation into slots provided in Clutching Element Housing 14.

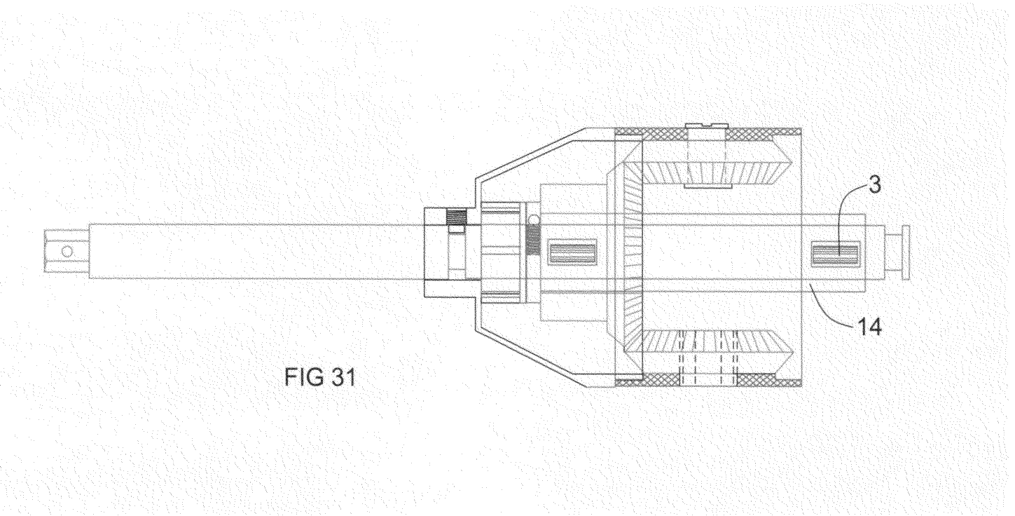

FIG. 31: Components 3 of the Clutching Element are installed into their respective slots provided in Clutching Element Housing 14.

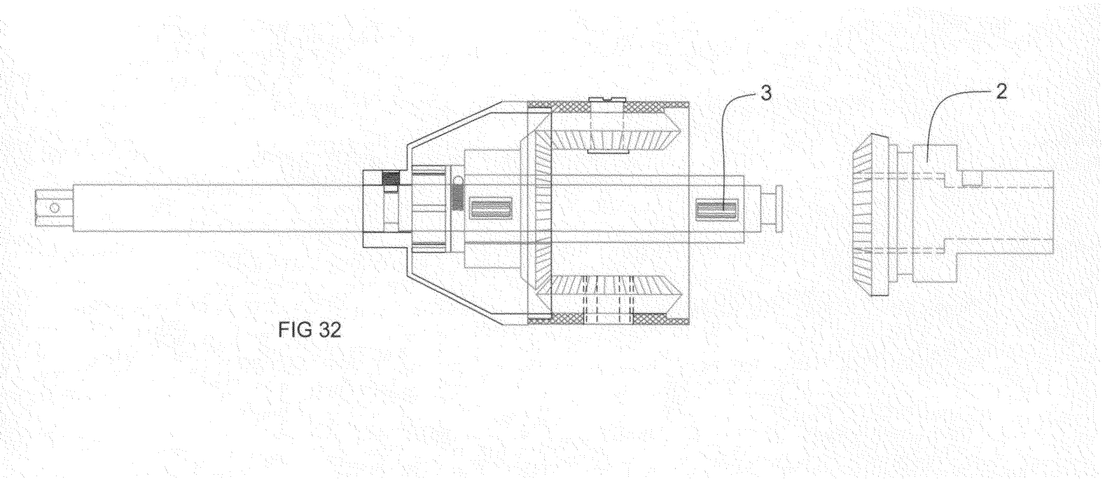

FIG. 32: The First Driving Element 2, is prepared to be slid onto Components 3 of the Clutching Element.

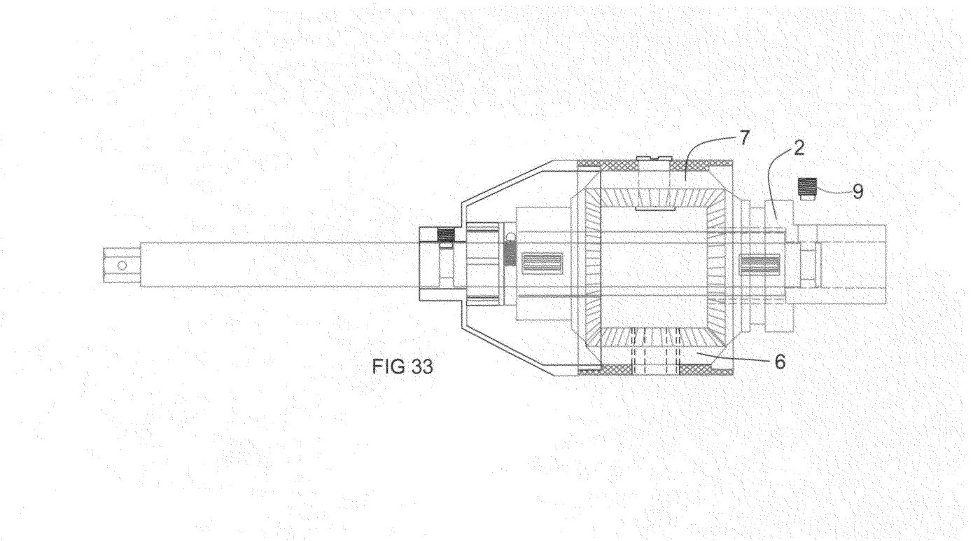

FIG. 33: The First Driving Element 2, is slid onto Components 3 of the Clutching Element and meshing with the First Rotating Element 6 and Second Rotating Element 7 of the Reversing Mechanism. Retainer Element 9 is prepared to be installed.

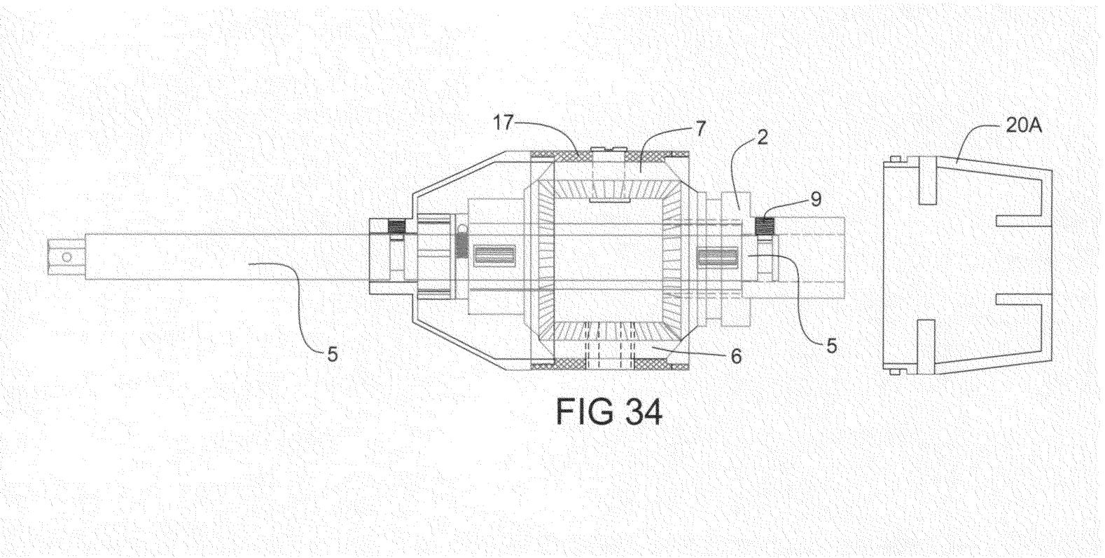

FIG. 34: Retainer Element 9 is installed to retain Second Driving Element 2 in position on Drive Shaft 5. Posterior Housing 20A is prepared for being slid over First Driving Element 2, then inserted into Reversing Mechanism Housing 17.

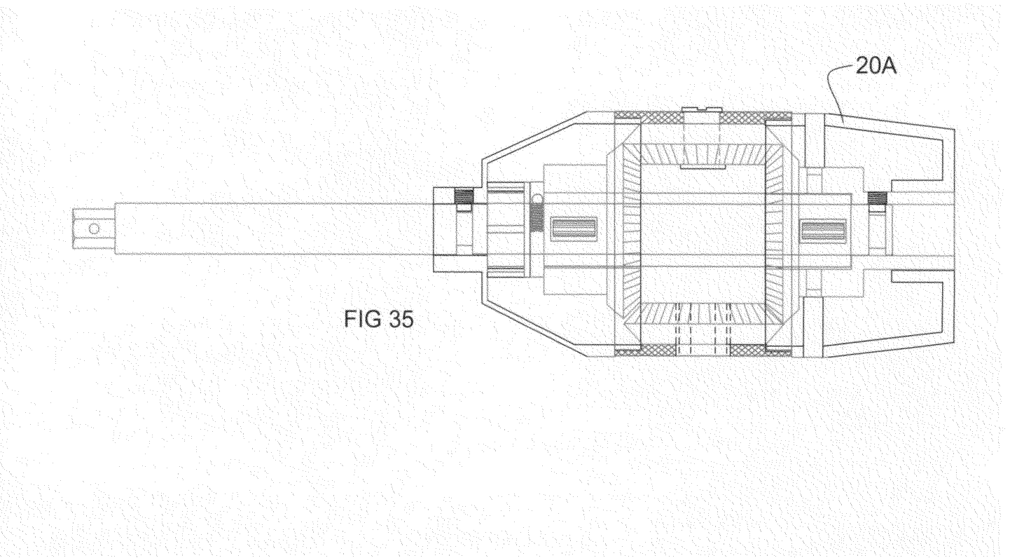

FIG. 35: Posterior Housing 20A, is slid onto First Driving Element 2, then inserted into

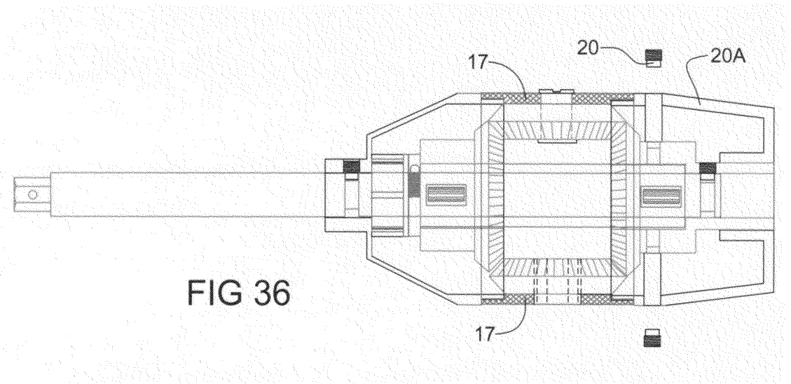

Reversing Mechanism Housing 17.

FIG. 36: A plurality of Retaining Elements 20, are prepared to be installed into Posterior Housing 20A.

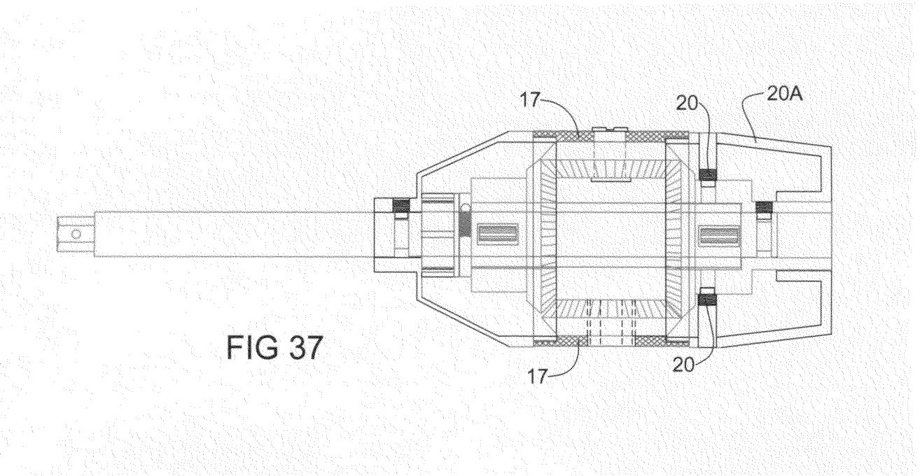

FIG. 37: A plurality of Retaining Elements 20 are installed, to secure First Driving Element 2, to Posterior Housing 20A.

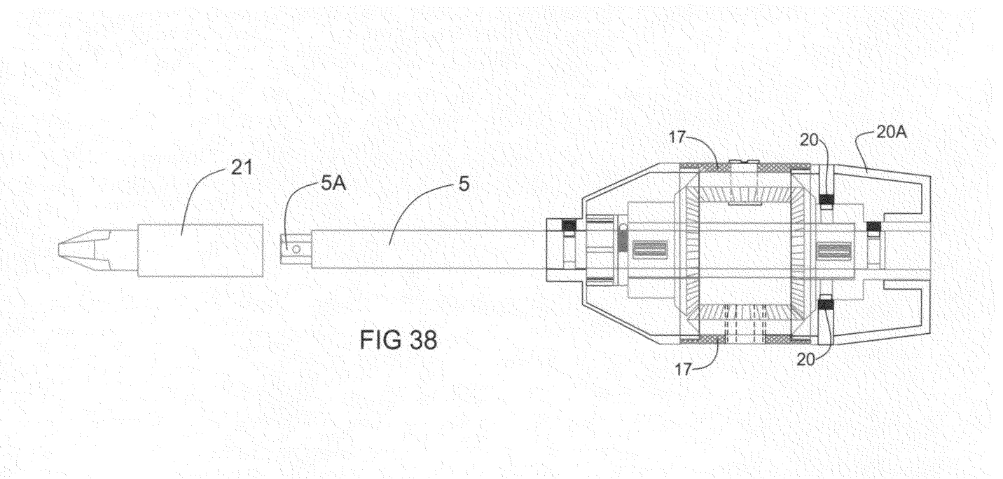

FIG. 38: Driver Bit 21 is prepared to be attached to Driving End 5a of Drive Shaft 5.

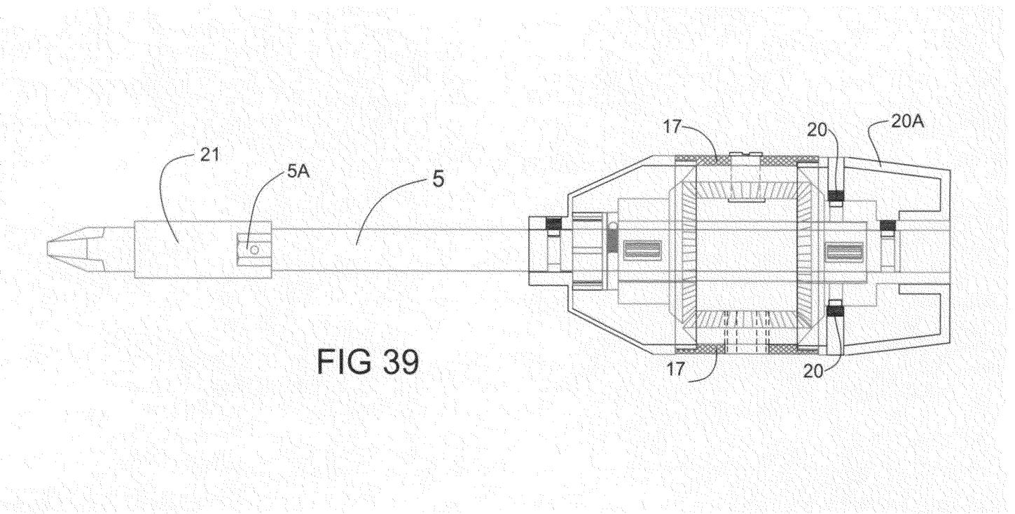

FIG. 39: Driver Bit 21 is attached to Driver End 5a of Drive Shaft 5.

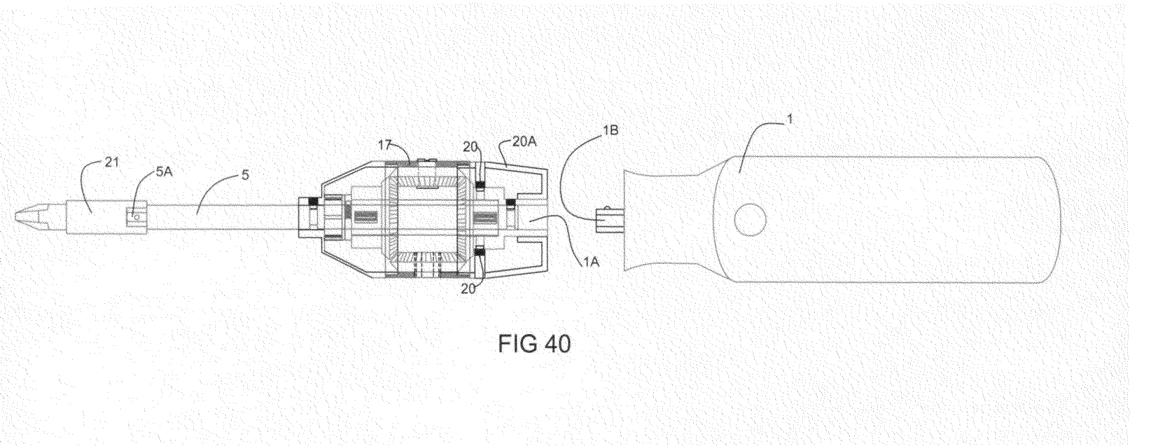

FIG. 40: Driving End 1B of Detachable Adjustable Handle 1, is prepared to be coupled to First Receptacle 1A of First Driving Element 2.

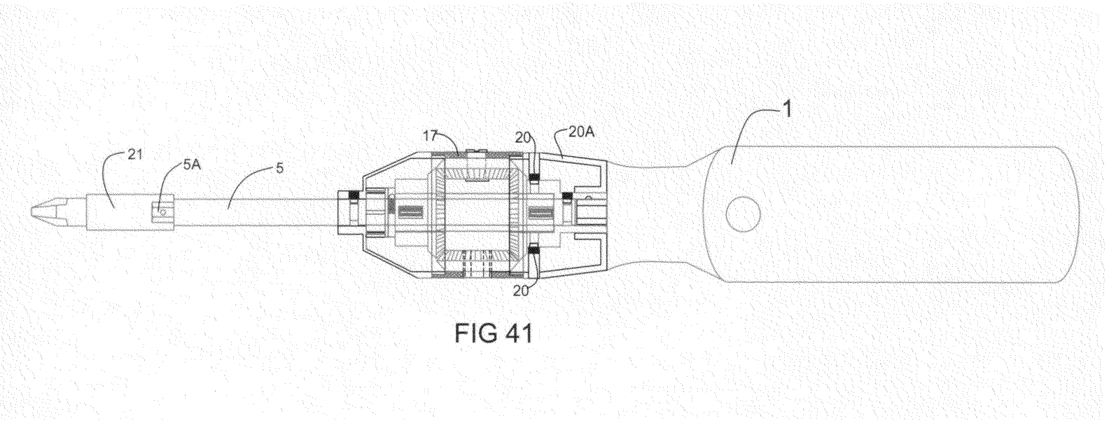

FIG. 41: Driving End 1B of Detachable Adjustable Handle 1 is coupled to first Driving Element 2.

FIG. 42: Detachable Adjustable Handle 1 is pivoted to an angle to increase torque.

FIG. 43: Detachable Adjustable Handle 1 is decoupled from First Receptacle 1A of First Driving Element 2.

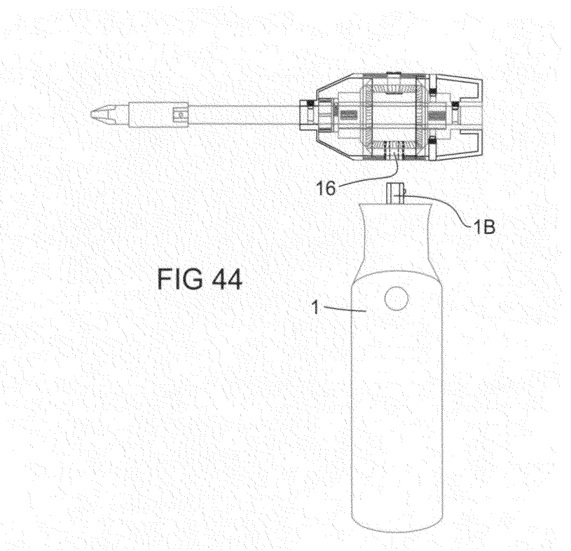

FIG. 44: Detachable Adjustable Handle 1 is prepared for being coupled to Second receptacle 16 of a gear of the Reversing Element

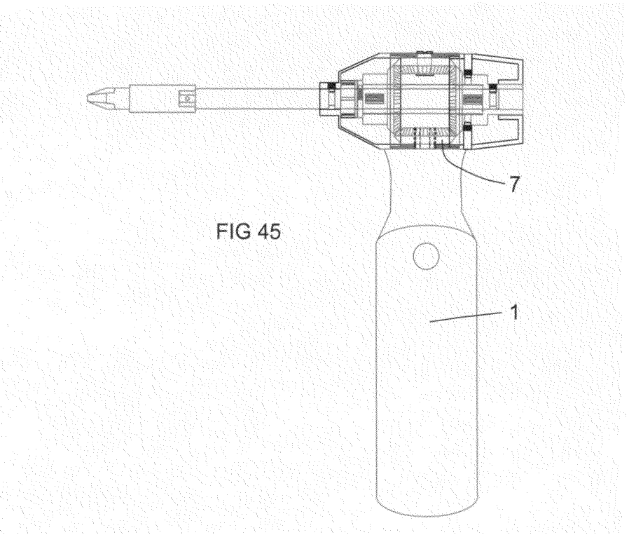

FIG. 45: Detachable Adjustable Handle 1 is coupled to Receptacle 16 of Second Rotating Element 7 of the Reversing Element.

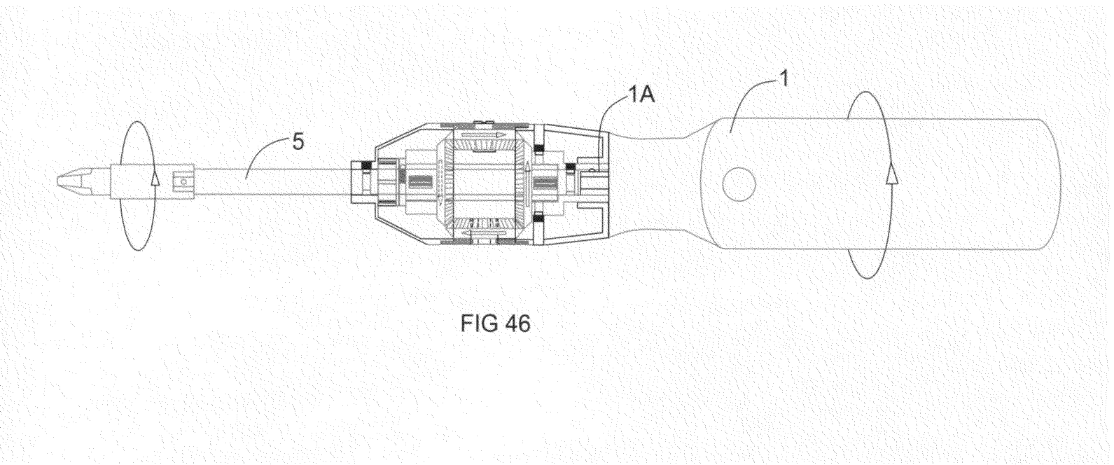

FIG. 46: Component rotation analysis, with Detachable Adjustable Handle 1 coupled to First Input Receptacle 1A and with double-drive mechanism set to clockwise output mode; clockwise input produces clockwise output.

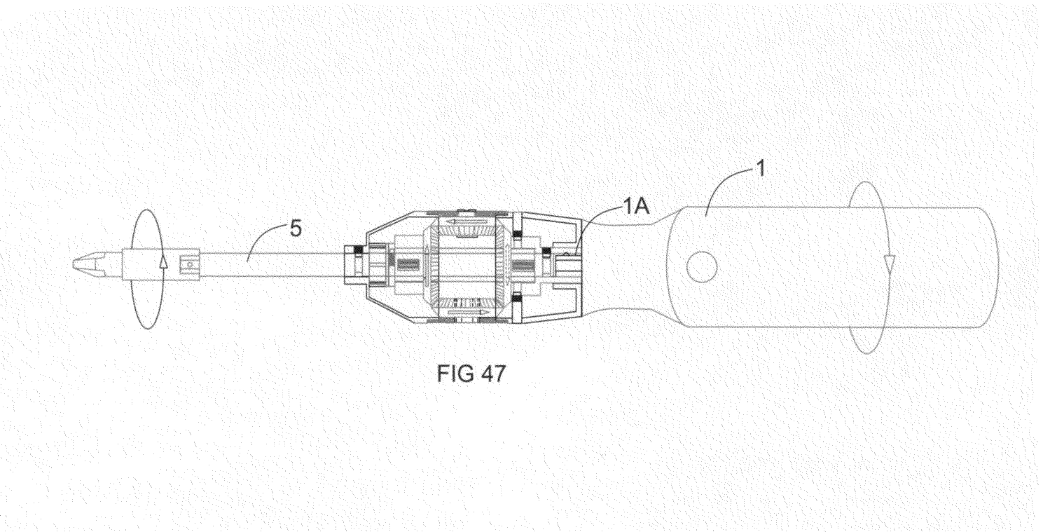

FIG. 47: Component rotation analysis with Detachable Adjustable Handle 1 coupled to First Input Receptacle 1A and with double-drive mechanism set to clockwise output mode; counter-clockwise input produces clockwise output. Solid arrows indicate direction of rotation; dashed arrows indicate direction of overrun.

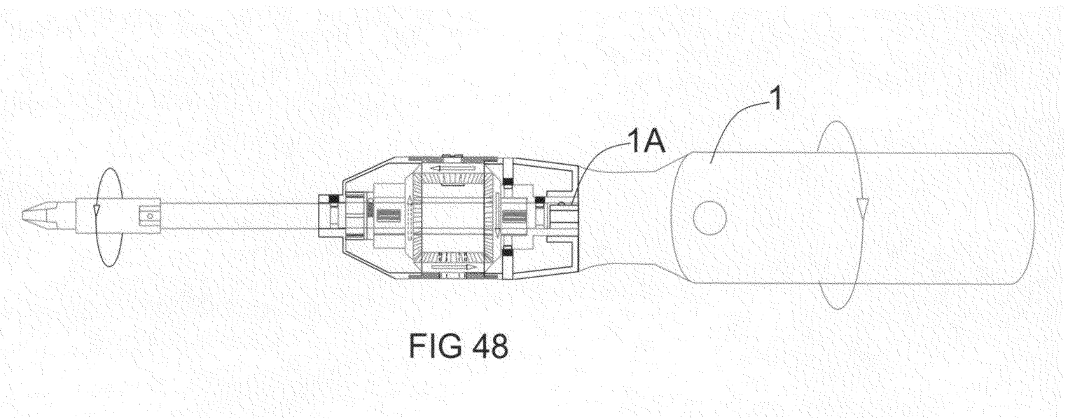

FIG. 48: Component rotation analysis with Detachable Adjustable Handle 1 coupled to First Input Receptacle 1A and with double-drive mechanism set to counter-clockwise output mode; counter-clockwise input produces counter-clockwise output. Solid arrows indicate direction of rotation; dashed arrows indicate direction of overrun.

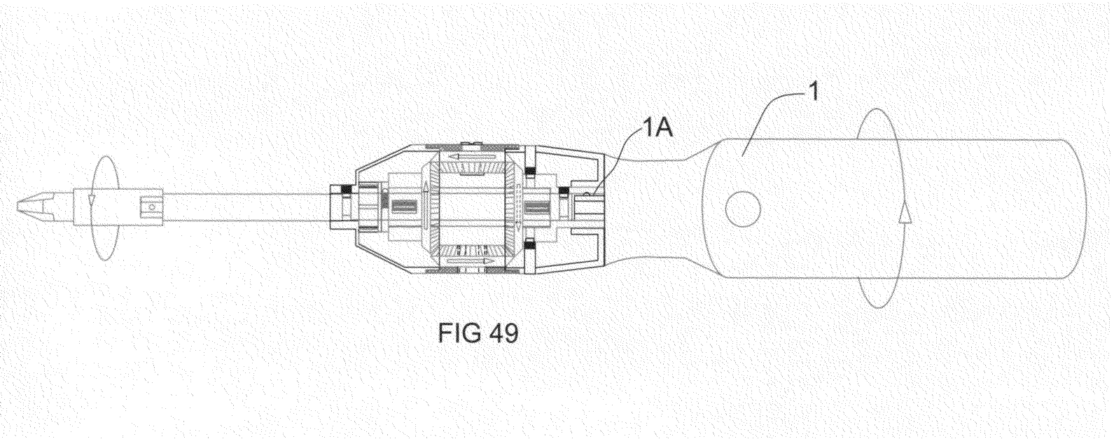

FIG. 49: Component rotation analysis with Detachable Adjustable Handle 1 coupled to First Input Receptacle 1A and with double-drive mechanism set to counter-clockwise output mode; clockwise input produces counter-clockwise output. Solid arrows indicate direction of rotation; dashed arrows indicate direction of overrun.

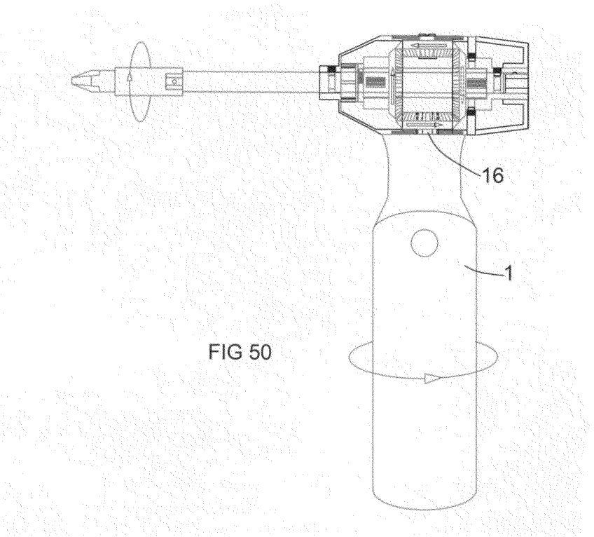

FIG. 50: Component rotation analysis with Detachable Adjustable Handle 1 coupled to Second Input Receptacle 16 and with double-drive mechanism set to clockwise output mode; clockwise input produces clockwise output. Solid arrows indicate direction of rotation; dashed arrows indicate direction of overrun.

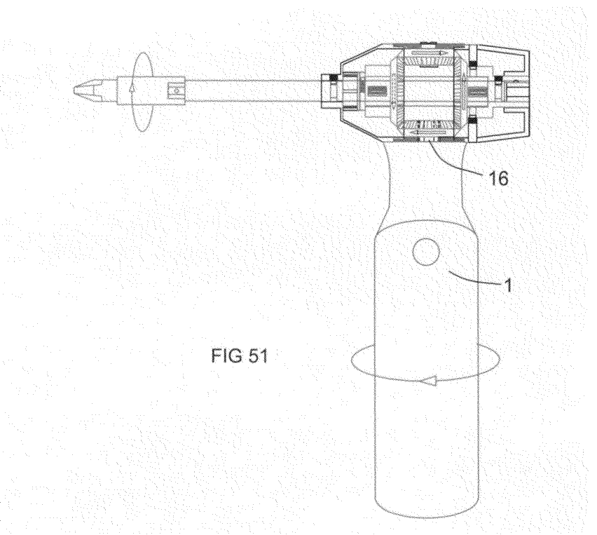

FIG. 51: Component rotation analysis with Detachable Adjustable Handle 1 coupled to Second Input Receptacle 16 and with double-drive mechanism set to clockwise output mode; counter-clockwise input produces clockwise output. Solid arrows indicate direction of rotation; dashed arrows indicate direction of overrun.

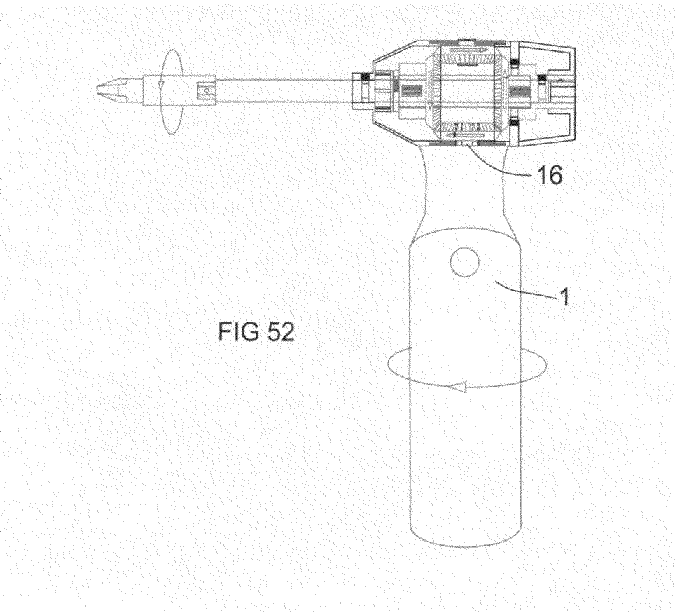

FIG. 52: Component rotation analysis with Detachable Adjustable Handle 1 coupled to Second Input Receptacle 16 and with double-drive mechanism set to counter-clockwise output mode; counter-clockwise input produces counter-clockwise output. Solid arrows indicate direction of rotation; dashed arrows indicate direction of overrun.

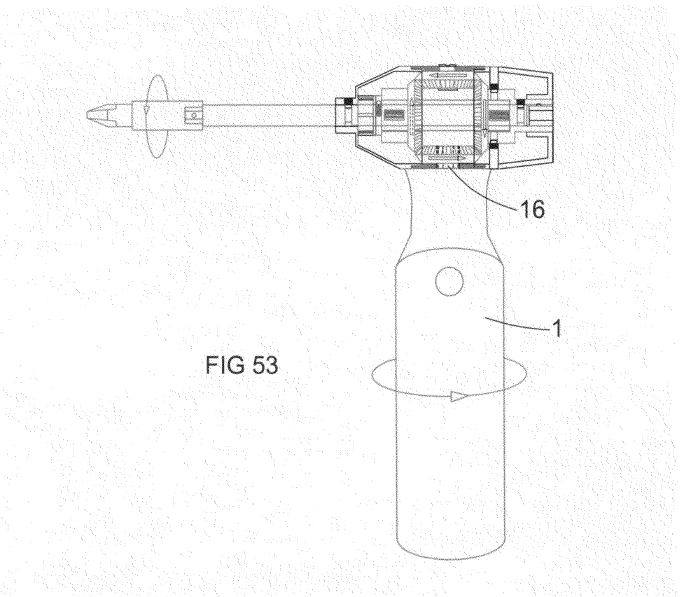

FIG. 53: Component rotation analysis with Detachable Adjustable Handle 1 coupled to Second Input Receptacle 16 and with double-drive mechanism set to counter-clockwise output mode; clockwise input produces counter-clockwise output. Solid arrows indicate direction of rotation; dashed arrows indicate direction of overrun.

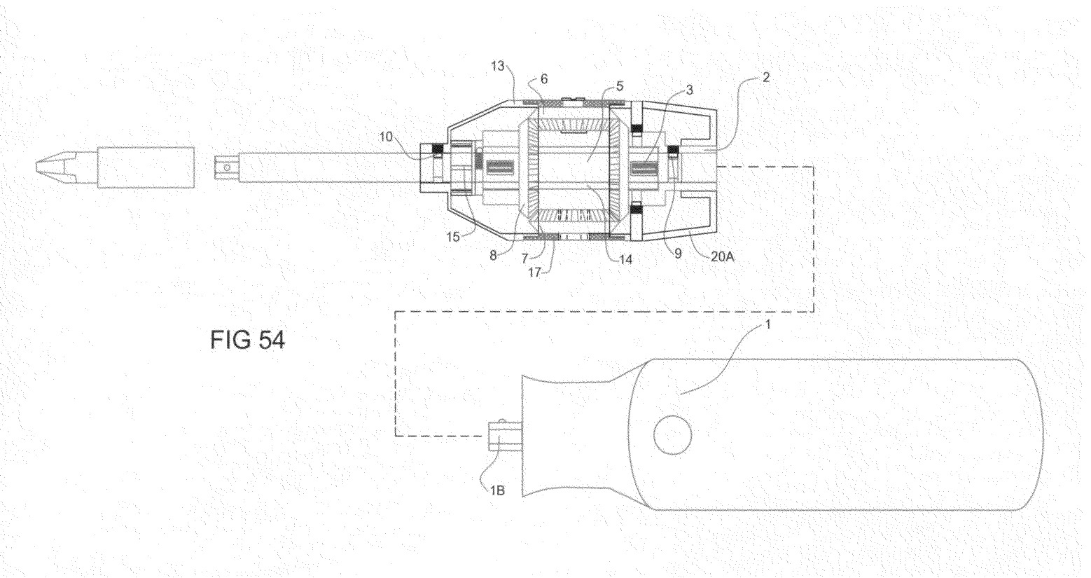

FIG. 54: Components are identified numerically to coincide with written description of the mechanics of the double-drive mechanism, that is set to clockwise output mode with clockwise rotation applied to the First Input Receptacle 1A.

FIG. 55: Components are identified numerically to coincide with written description of the mechanics of the double-drive mechanism, that is set to clockwise output mode with counter clockwise rotation applied to the First Input Receptacle.

FIG. 56: Components are identified numerically to coincide with written description of the mechanics of the double-drive mechanism, which is set to clockwise output mode with clockwise rotation applied to the Second Input Receptacle 16.

FIG. 57: Double-drive mechanism is set to clockwise output mode with clockwise rotation applied to the Second Input Receptacle 16.

FIG. 58: Because the dual-drive self-ratcheting mechanism can employ any mechanical means, such as, but, not limited to, at least a pair of ratchet wheels and pawls or roller type clutches, or their equivalents, to entrain a driveshaft to rotate axially in only one direction, FIG. 58 illustrates such a mechanism using a plurality of ratchet wheels engaged by pawls, to entrain a driveshaft to rotate axially; the reversing mechanism is being ‘directly-driven’ by and directly coupled to an input handle, that is repeatedly and alternatingly turned axially, in clockwise then counterclockwise rotation.

FIG. 59: In this arrangement, a pair of ratchet wheels and pawls are employed to cause the dual-drive, self-ratcheting action. Shown is a belt-drive or chain-drive arrangement for coupling the input handle ‘indirectly’, to the reversing mechanism.

FIG. 60: In this arrangement, a pair of ratchet wheels and pawls are employed to cause the dual-drive, self-ratcheting action. Shown is a belt-drive or chain-drive arrangement with an ergonomic angled-handle, for coupling the input handle ‘indirectly’, to the reversing mechanism.

FIG. 61: In this arrangement, a pair of ratchet wheels and pawls are employed to cause the dual-drive, self-ratcheting action. Shown is a belt-drive or chain-drive with an in-line arrangement, for coupling the input handle ‘indirectly’, to the reversing mechanism.

FIG. 62: Exploded-view of the Anti-Rotation Mechanism, that enables the device to be operated in a direct-drive, non-ratcheting mode, includes Pivoting Stabilizer Lever 24 with Cam 25 on its underside, that rotates in Triangular Slot 26 of slideable Follower Frame 27 with Extension 34, Follower 31, Anti-Rotation Post 32. Saddle 30 has curved underside, a Straight Slot 29 and a centered opening to receive fastening hardware not shown.

FIG. 63: Cam 25 is in initial position in triangular slot 26, while Knob 28 on underside of Follower Frame 27, is prepared to be guided in straight-slot 29 of Saddle, to cause linear displacement of Follower Frame 27.

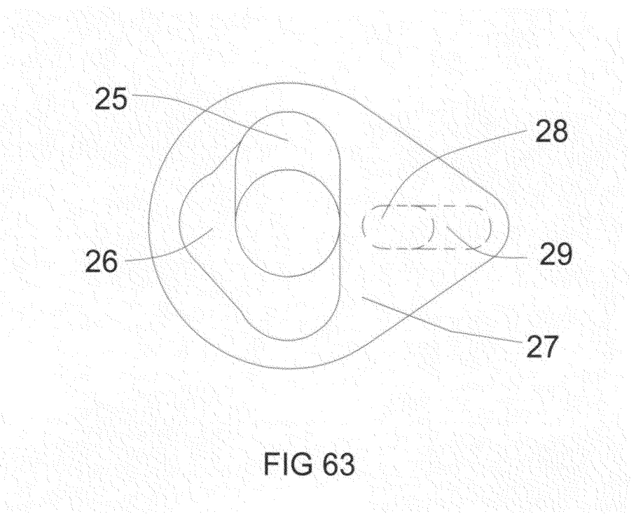

FIG. 64: Cam 25 is partially rotated in triangular slot 26, while Knob 28 on underside of Follower Frame 27, is guided in straight-slot 29 of Saddle, to cause linear displacement of Follower Frame 27.

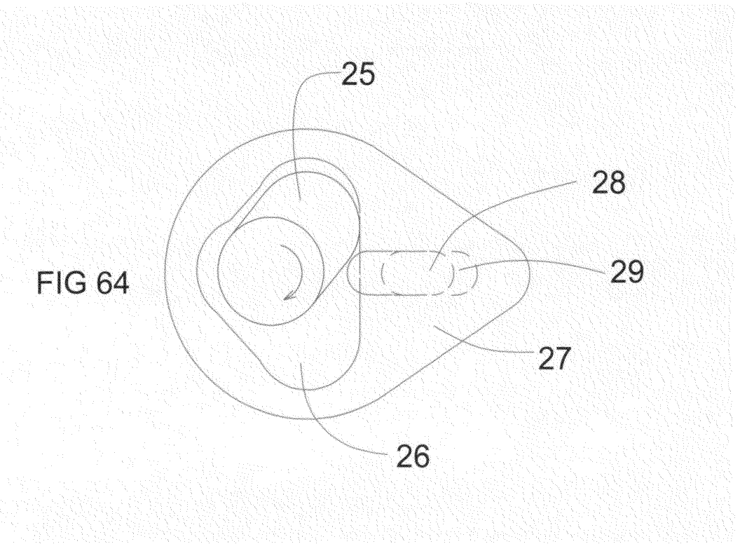

FIG. 65: Cam 25 is partially rotated further in triangular slot 26, while Knob 28 on underside of Follower Frame 27, is guided in straight-slot 29 of Saddle, to cause linear displacement of Follower Frame 27

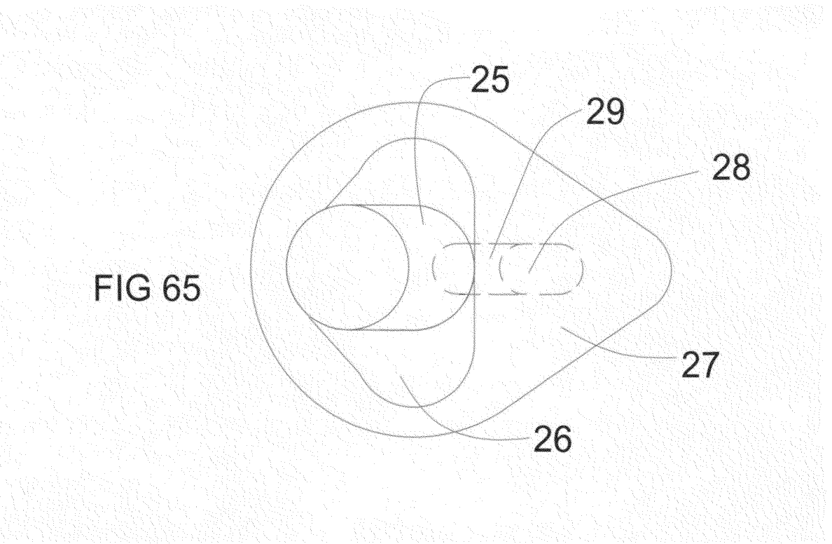

FIG. 66: Cam 25 is partially rotated further in triangular slot 26, while Knob 28 on underside of Follower Frame 27, is guided in straight-slot 29 of Saddle, to cause linear displacement of Follower Frame 27

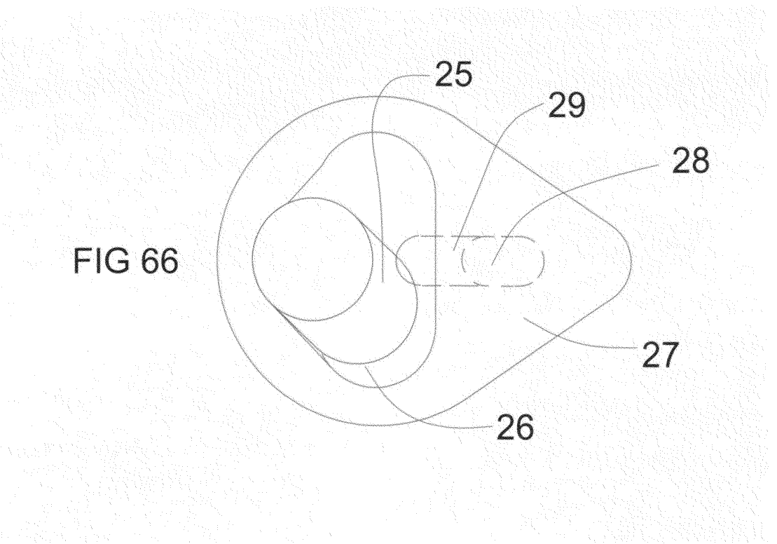

FIG. 67: Cam 25 is rotated 180-degrees from initial position in triangular slot 26, while Knob 28 on underside of Follower Frame 27, is guided in straight-slot 29 of Saddle, to cause full linear displacement of Follower Frame 27.

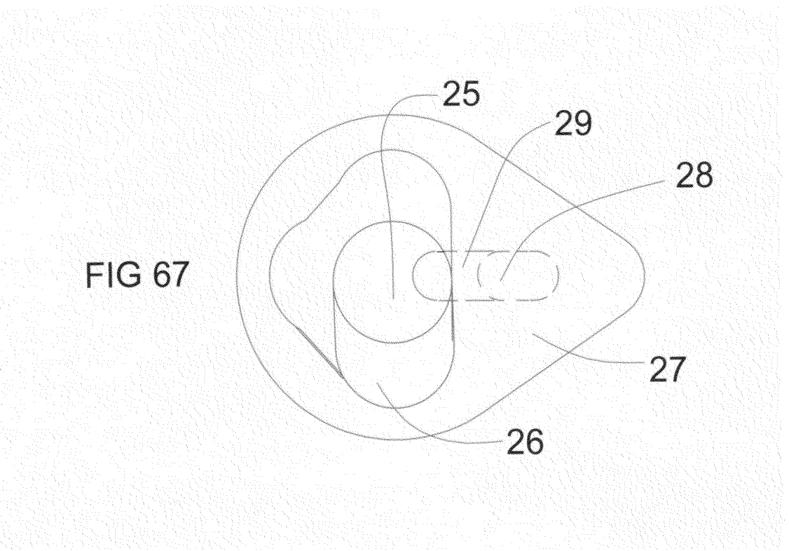

FIG. 68: Exploded view of the components of the Anti-Rotation Mechanism, in correct order for assembly. Axle Component 18, Pivoting Stabilizer Lever 24, Follower Frame (Extension 34, Angled Slot 33, Follower Pin 31, Anti-Rotation Post 32, Knob 28), Saddle 30 with Straight Slot 29, Housing 17, Reversing Element 6 and Axle Component 19.

FIG. 69: The Pivoting Stabilizer Lever facing the input end. Anti-Rotation Post 32 is fully inserted into opening in Reversing Element 6, to prevent rotation of Reversing Element 6.

FIG. 70: Top view of the Pivoting Stabilizer Lever 24 facing the input end with Cam 25 on the underside, indicated by dashed lines.

FIG. 71: The position of Follower Frame 27 of FIG. 69.

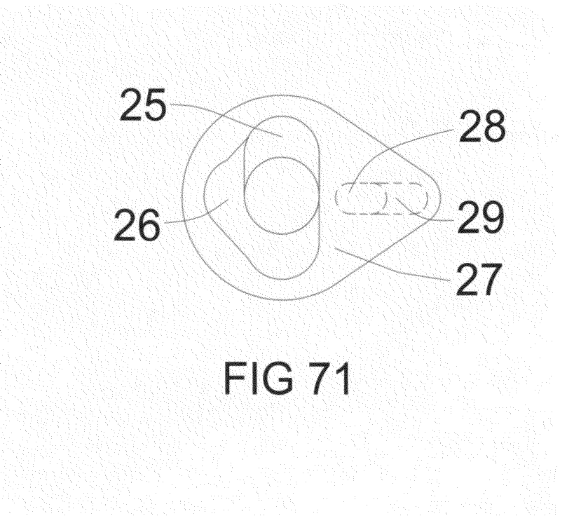

FIG. 72: Side view of the Pivoting Stabilizer Lever partially pivoted, causing Anti-Rotation Post 32 to be partially lifted from the opening in Reversing Element 6.

FIG. 73: Top view of the Pivoting Stabilizer Lever partially pivoted.

FIG. 74: Follower Frame is slightly displaced, from the partial pivoting of Pivoting Stabilizer Lever.

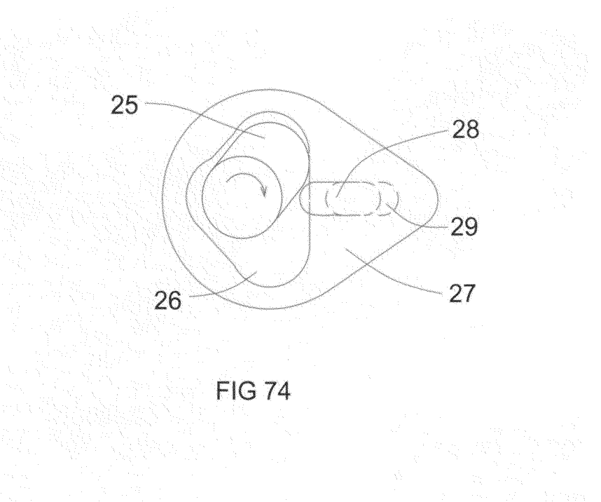

FIG. 75: Side view of Pivoting Stabilizer Lever 24, pivoted to perpendicular position; Anti-Rotation Post 32 is fully disengaged from opening in Reversing Element 6, thereby enabling Reversing Element 6 to rotate.

FIG. 76: Top view of the Pivoting Stabilizer Lever 24, pivoted 90 degrees, to disengage Anti-Rotation Post 32, to enable rotation of Reversing Element and activation of dual-drive mechanism. Cam 25 is shown with dashed lines to indicate its location on the underside.

FIG. 77: Follower Frame is displaced fully forward.

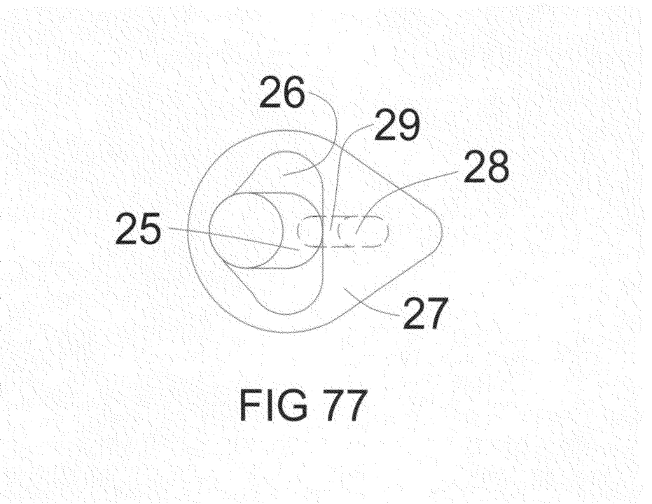

FIG. 78: Pivoting Stabilizer Lever 24 facing output end, 180-degrees from original position, for standard driving mode.

FIG. 79: Top view of Pivoting Stabilizer Lever 24, pivoted to 180-degrees from original position in FIG. 70, to face output-end for standard driving mode.

FIG. 80: Top view of Follower Frame displaced fully-forward, caused by Pivoting Stabilizer Lever, pivoted to face output end.

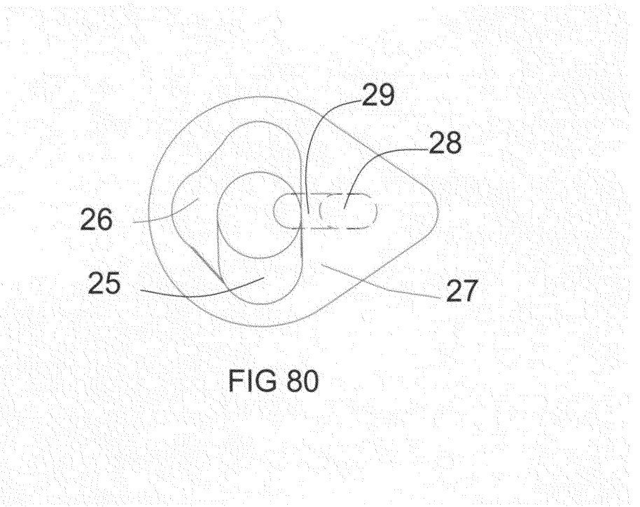

FIG. 81: Visual surface markers must be aligned, for the Anti-Rotation Post 32 to be lowered into opening provided in hub-side of Reversing Element 6, to prevent Reversing Element 6 from rotating.

FIG. 82: Misaligned visual surface markers of FIG. 81, with the Pivoting Stabilizer

Lever in perpendicular position, indicate the double-drive feature can be activated.

FIG. 83: Misaligned visual surface markers, with the Pivoting Stabilizer Lever 24, facing the output end, indicate the double-drive feature can be activated and can be employed as a conventional ratchet.

FIG. 84: Exploded-view of the gearing arrangement of an invertible step-up and step-down transmission attachment and its lower-half housing.

FIG. 85: Internal view of a gearing arrangement of a transmission in step-up orientation, nested in its lower-half housing. Numerous step-up ratios are possible; this arrangement produces 5 revolutions at the output. from one revolution of the input.

FIG. 86: View of the inverted gearing arrangement of the transmission of FIG. 85, for step-down; 5 revolutions of the input, causes 1 revolution at the output, for high torque requirements.

FIG. 87: Assembled step-up and step-down invertible transmission attachment, with cover installed with fastening hardware.

FIG. 88: Adapter with a spring-loaded ball retainer installed at each end, is prepared to be attached to couple the Detachable Adjustable Handle 1 to a Reversing Element, for right-angle driving.

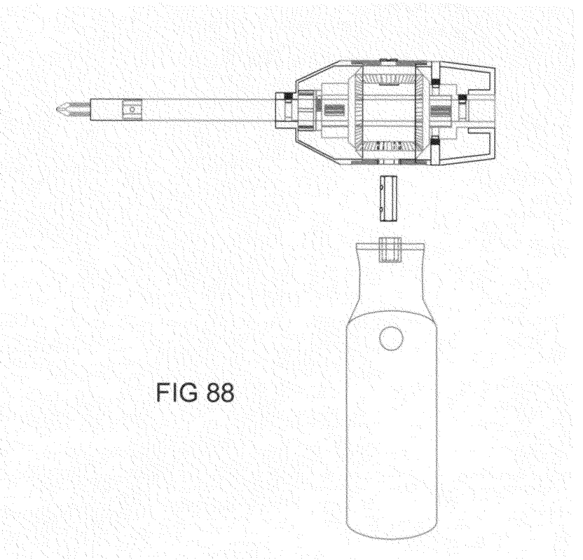

FIG. 89: Adapter with a spring-loaded ball retainer installed at each end, is coupled to retain Detachable Adjustable Handle 1 for right-angle driving.

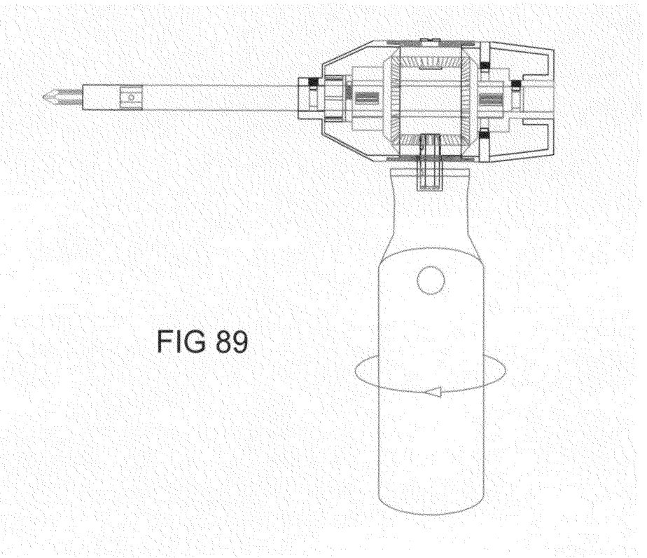

FIG. 90: The step-up end of the step-up and step-down transmission, is prepared to be attached to a Reversing Element.

FIG. 91: The step-up end of the step-up and step-down transmission, is coupled to a Reversing Element. One revolution applied to Detachable Adjustable Handle 1, causes 5 revolutions of Reversing Element for a right-angle drive.

FIG. 92: The step-down end of the step-up and step-down transmission, is prepared to be coupled to Driving Element 2.

FIG. 93: For increased torque to finish-tightening a fastening hardware, the step-down end of the step-up and step-down transmission, is coupled to First Driving Element 2. Five alternating 180-degree turns of Detachable Adjustable Handle 1, causes ½ rotation at the output. Device shown, is set to clockwise output mode.

FIG. 94: For increased torque to finish-tightening a fastening hardware, the step-down end of the step-up and step-down transmission, is coupled to First Driving Element 2. Five alternating 180-degree turns of Detachable Adjustable Handle 1, causes ½ rotation at the output. Device shown, is set to counterclockwise output mode.

FIG. 95: The step-up end of the step-up and step-down transmission, is prepared to be coupled to the First Driving Element 2.

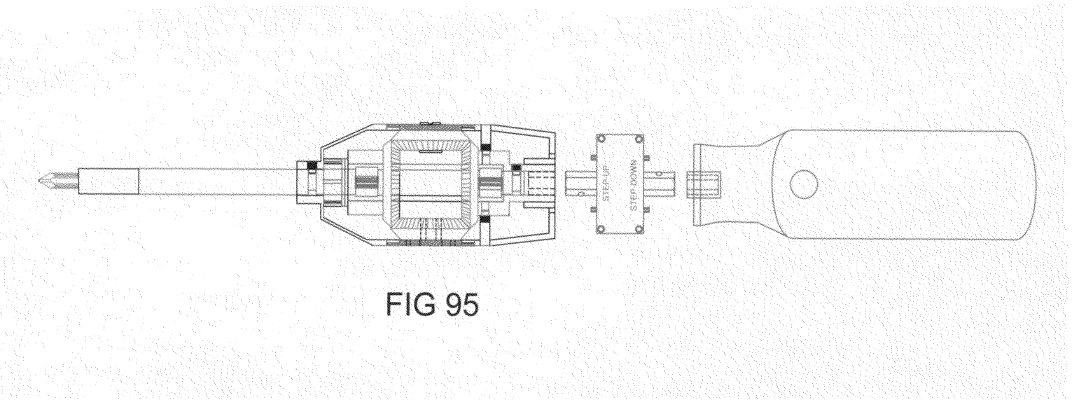

FIG. 96: The step-up end of the step-up and step-down transmission, is coupled to the First Driving Element 2. ½ clockwise revolution applied to the Detachable Adjustable Handle 1, produces 2½ clockwise revolutions at the output.

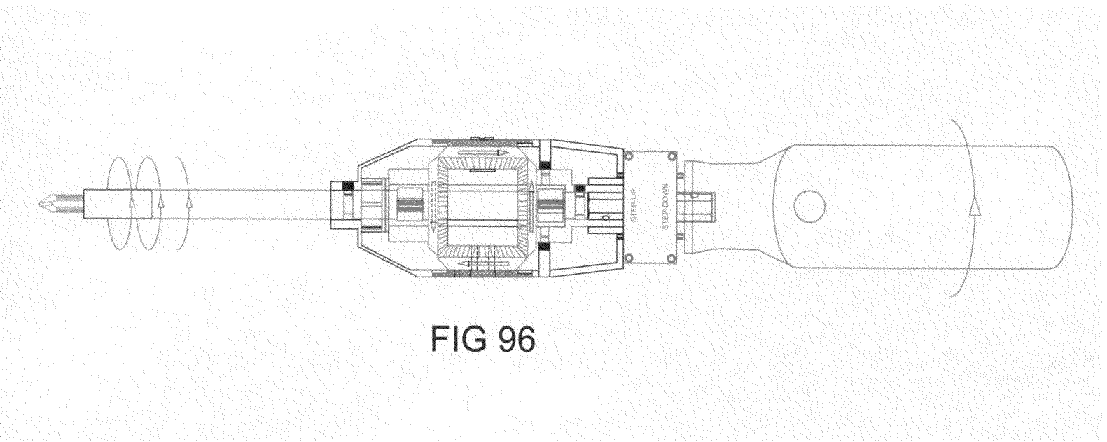

FIG. 97: For increased speed for driving a fastener, the step-up end of the step-up and step-down transmission, is coupled to the First Driving Element 2. One half counterclockwise revolution applied to the Detachable Adjustable Handle 1, produces 2-1/2 clockwise revolutions at the output.

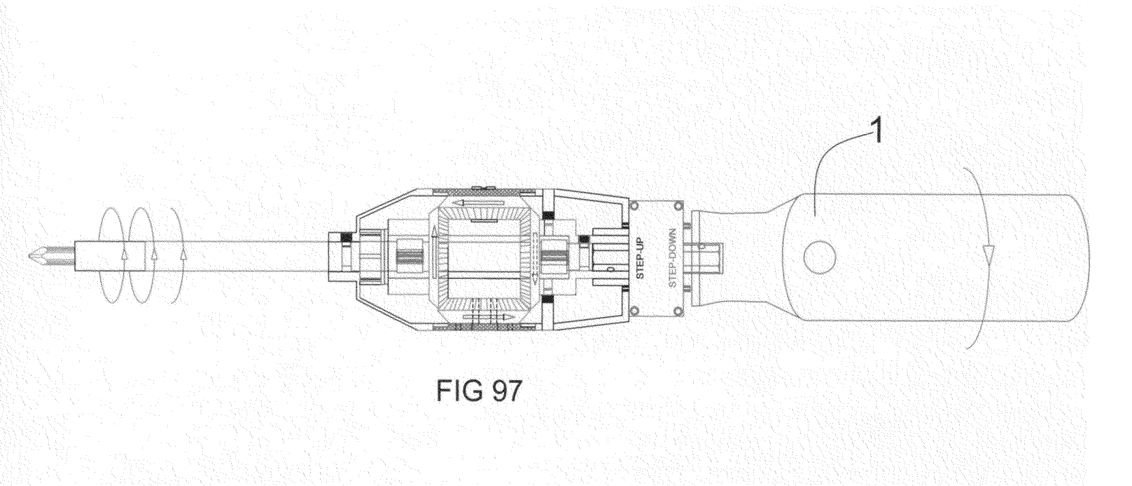

### DESCRIPTION OF THE PREFERRED EMBODIMENT

The following is a description of the mechanics of the mechanism, involving a rotational analysis of the cooperation of components of the self-ratcheting dual-drive mechanism.

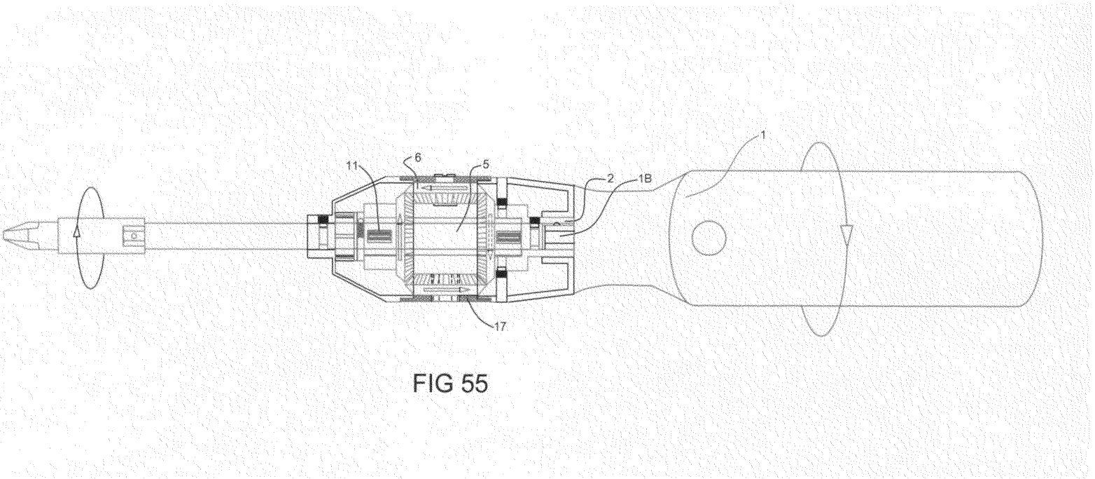

In FIG. 54, with the dual-drive self-ratcheting mechanism secured into clockwise shaft-rotation mode, Detachable Adjustable Handle 1, is provided with Coupling Member 1B, that is coupled concentrically into the hub of First Driving Element 2 and turned clockwise axially, while Reversing Mechanism Housing 17 is held stationary, causing said First Driving Element 2 to rotate clockwise and entrain a plurality of Member 3 which become wedged between bore of First Driving Element 2 and Drive Shaft 5; causing Drive Shaft 5 to rotate clockwise; while Second Rotating Element 6 of Reversing Mechanism, is caused to rotate clockwise and First Rotating Element 7 of Reversing Mechanism is caused to rotate counterclockwise; causing Second Driving Element 8, to rotate counterclockwise to override Drive Shaft 5. Regardless of the direction of axial rotation applied to Detachable Adjustable-Angle Handle 1, in clockwise output mode, Drive Shaft rotation is always clockwise. Anterior Housing 13, rotatably mounted onto Drive Shaft 5 and keyed to Switch Element 15, which is coupled to Clutch Element Housing 14, is a switching means to change the double-drive self-ratcheting mechanism, from clockwise to counterclockwise shaft rotation and from counterclockwise to clockwise shaft rotation.

Retaining Element 9 in a groove in Drive Shaft 5, retains Anterior Housing 13 in place on Drive Shaft 5, to prevent longitudinal movement of Anterior Housing.

Retaining Element 10 in a groove in Drive Shaft 5, retains Drive Shaft 5 and Posterior Housing 20A, to prevent their longitudinal movement.

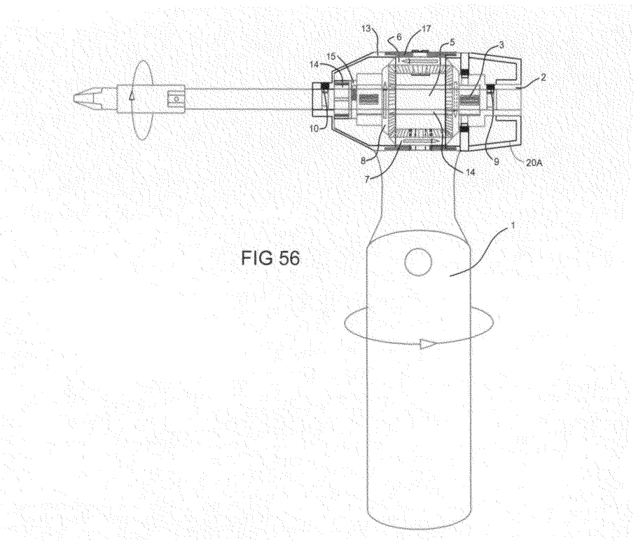

In FIG. 55, with the dual-drive mechanism secured into clockwise shaft-rotation mode, Detachable Adjustable Handle 1 is provided with Driving Element 1B , that is inserted into hub of 1st Driving Element 2 and turned counterclockwise axially, while Reversing Mechanism Housing 17 is held stationary, causing said 1st Driving Element 2 to rotate counterclockwise and override Drive Shaft 5; while Second Rotating Element 6 of Reversing Mechanism, is caused to rotate counterclockwise and First Rotating Element 7 of Reversing Mechanism is caused to rotate clockwise; causing Second Driving Element 8, to rotate clockwise to entrain a plurality of Member 11 which become wedged between bore of Driving Element 2 and Drive Shaft 5; causing Drive Shaft 5 to rotate clockwise.

Regardless of the direction of rotation applied to Detachable Adjustable Handle 1, in clockwise output mode, Drive Shaft 5 axial rotation is always clockwise.

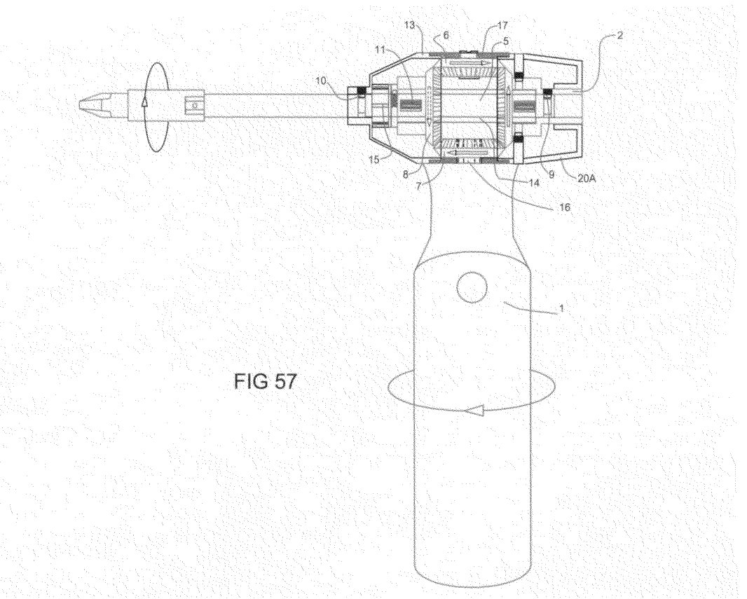

In FIG. 56, with the dual-drive mechanism secured into clockwise shaft-rotation mode, Driving Element 1B of Detachable Adjustable Handle 1, is coupled to Second Rotating Element 6 of Reversing Mechanism for right-angle driving. Detachable Adjustable Handle 1 is turned axially clockwise to cause the same component rotation, as described in FIG. 54.

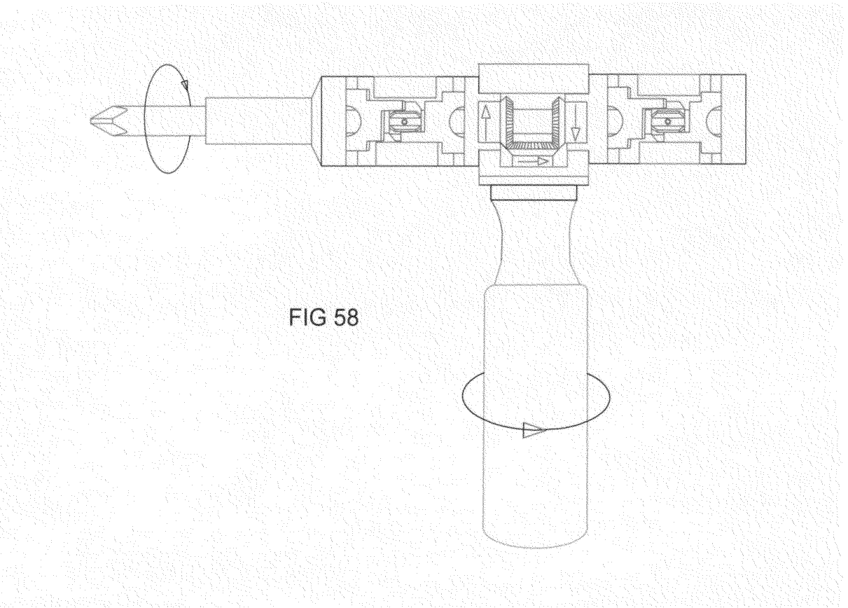

In FIG. 57, right-angle drive, with the dual-drive mechanism secured into clockwise shaft-rotation mode, Driving Element 1B of Detachable Adjustable Handle 1, is coupled to Second Rotating Element of Reversing Mechanism. Detachable Adjustable Handle 1 is turned axially counterclockwise to cause the same component rotation as described in FIG. 55.

While the description contains many specificities, these must not be construed as limitations on the scope of the invention, but rather as an exemplification of a general configuration thereof. Numerous alternative arrangements of identical and/or equivalent mechanical components, are possible for producing a clockwise output from an oscillatory input and for producing counter-clockwise output from an oscillatory input, within the same embodiment. Even though the self-ratcheting double-drive mechanism invention has numerous applications such as rotary-operated hand tools, kitchen gadgets, wine accessories, automotive accessories and industrial equipment, the manually-operated ratchet screwdriver is enlisted, not as the invention, but, as an ideal exemplification of an application for the invention, in order to explain the advantages of the mechanism.

What is claimed:

1. (canceled)

2. (canceled)

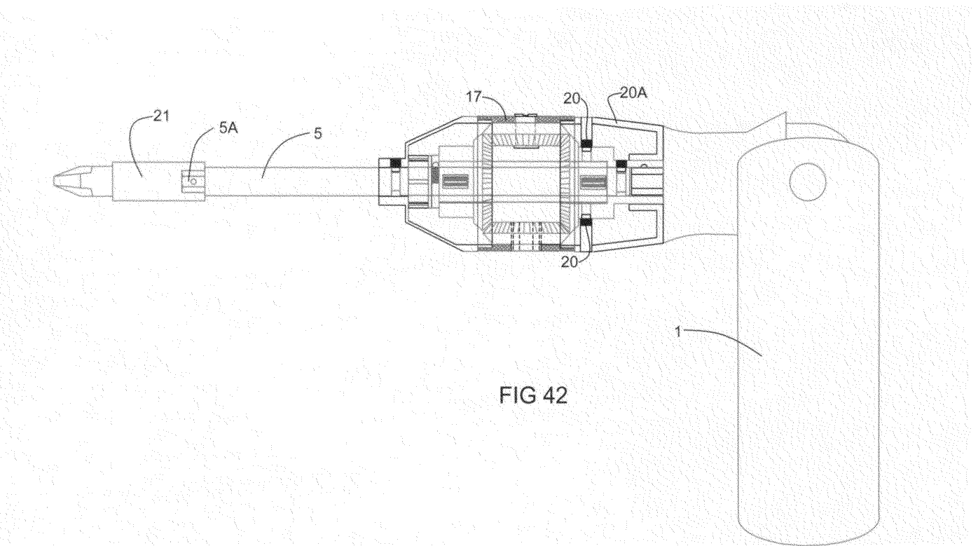

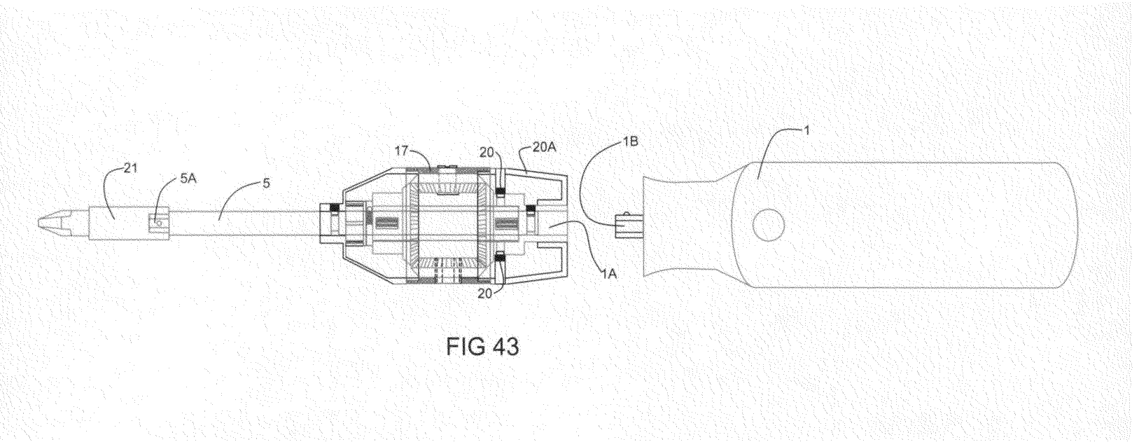

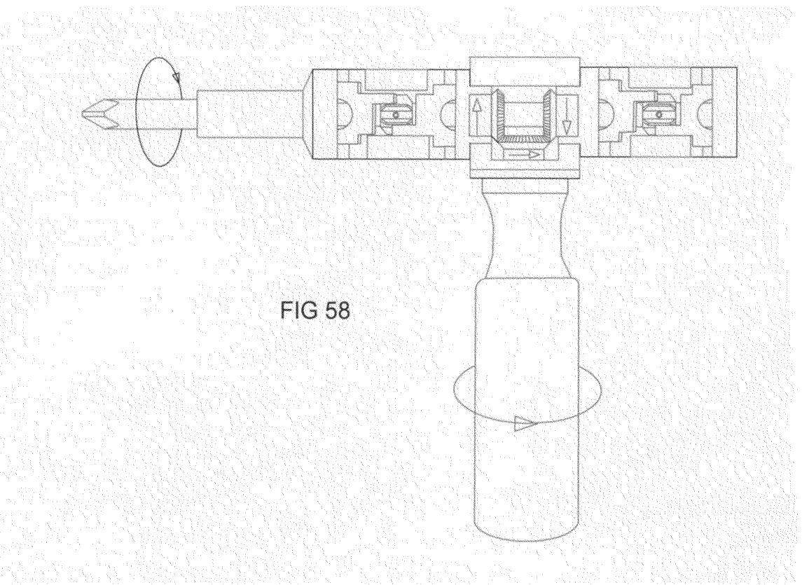

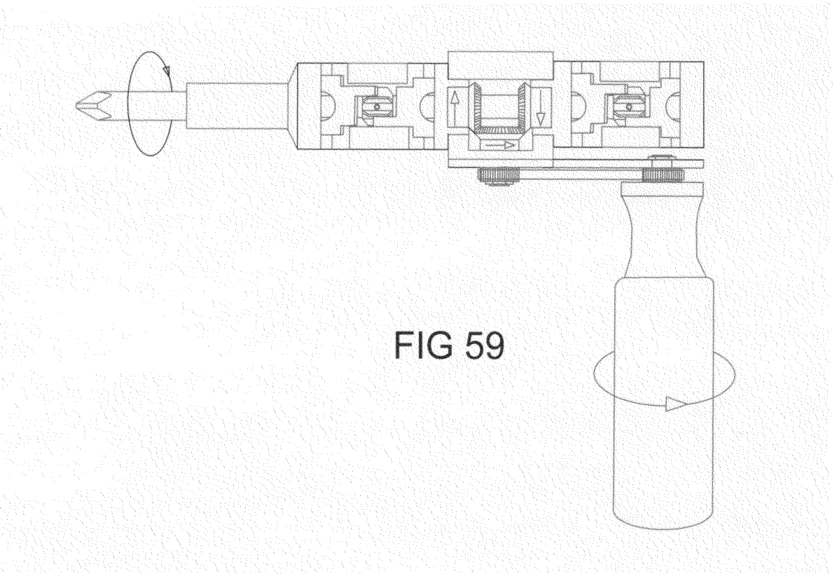

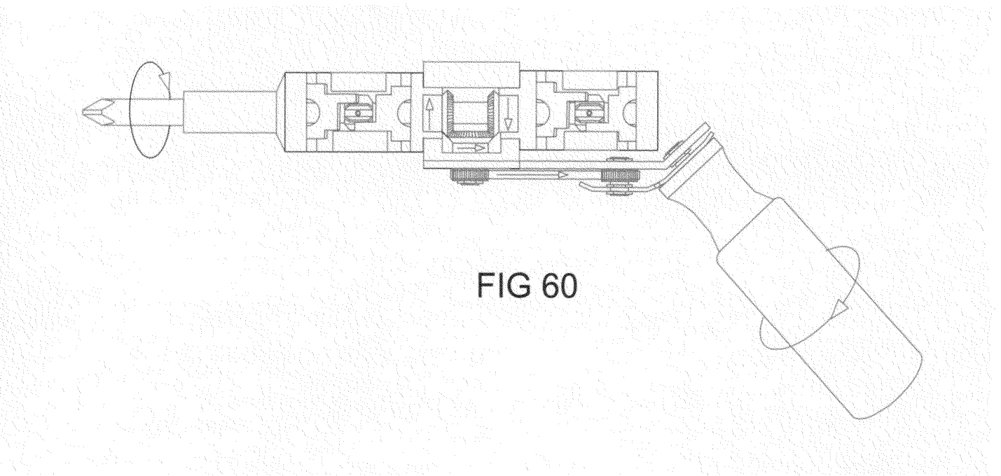

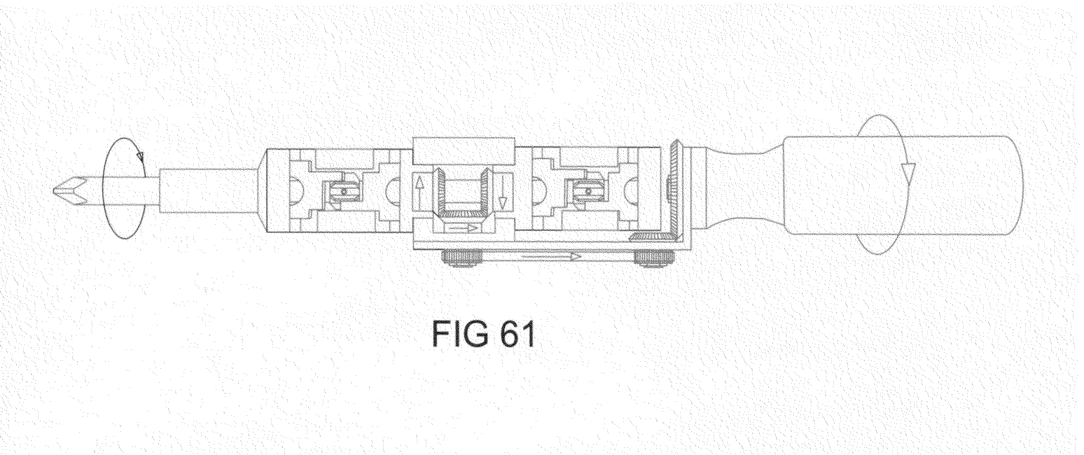

3. A drive mechanism, that, within the same embodiment, can be set to clockwise rotational output mode and converts oscillatory motion applied to its input, into solely clockwise rotation motion at its output; can be set to counterclockwise rotational output mode and converts oscillatory motion applied to its input, into solely counter-clockwise rotation motion at its output and can be set to standard direct drive mode and comprising:
a drive shaft;
a pair of driving elements mounted on said driveshaft, with each said driving element coupled to a device, that engages the driveshaft and oriented the same on the driveshaft, so that the driveshaft is always entrained in only one direction of axial rotation, when one of the driving elements is rotated in that direction, while the driveshaft is overrun by the other driving element rotated in the opposite direction;
a reversing mechanism, that couples the pair of driving elements together and causes them to always rotate in opposite directions, so that one driving element entrains the driveshaft and the other driving element overrides the driveshaft, thus causing the driveshaft to always rotate axially, in only one direction, regardless of the direction of rotation of the driving elements;
a detachable input member, for coupling to an inline input port to rotate axially in clockwise and counterclockwise direction and pivot to any angle up to perpendicular, akin to a pistol-grip, for increased torque, for coupling to an alternate non-inline input port to rotate axially in clockwise and counterclockwise direction as well as swing radially, in clockwise and counterclockwise direction and couples either directly to the reversing mechanism, such as proposed in FIGS. 56, 57 and 58, or indirectly to the reversing mechanism, such as proposed in FIGS. 59, 60 and 61 for engaging a selected one of the driving elements and fitted with a driving piece insert, that is provided with a retaining element at each end;
a first input receptacle for coupling said Detachable Input Member to a Driving Element, when Detachable Input Member is disposed coaxial with shaft as proposed in FIG. 41 and FIG. 42 and with Detachable Input Member able to rotate axially in clockwise and counterclockwise direction;
a second input receptacle, for coupling the Detachable Input Member radially, to the Reversing Mechanism, for simultaneously securing the Reversing Mechanism in stationary mode, while user single-handedly applies axial rotation, to the Detachable Input Member, in alternating clockwise and counterclockwise direction, thereby enabling user's opposite hand to hold a workpiece.

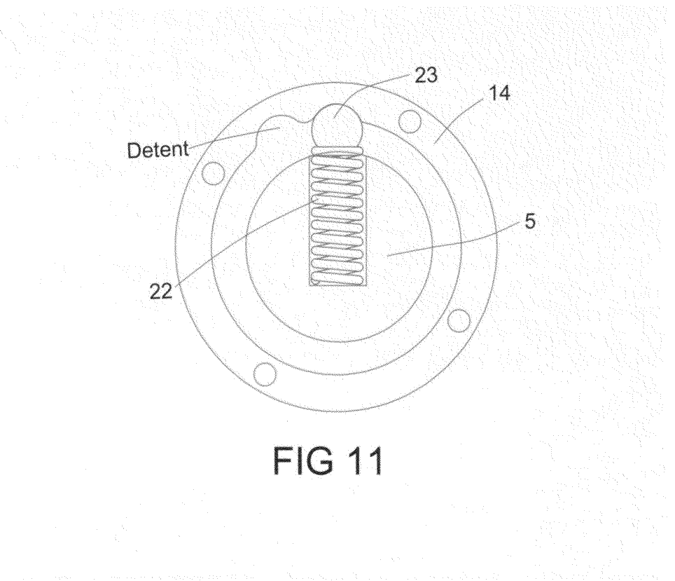

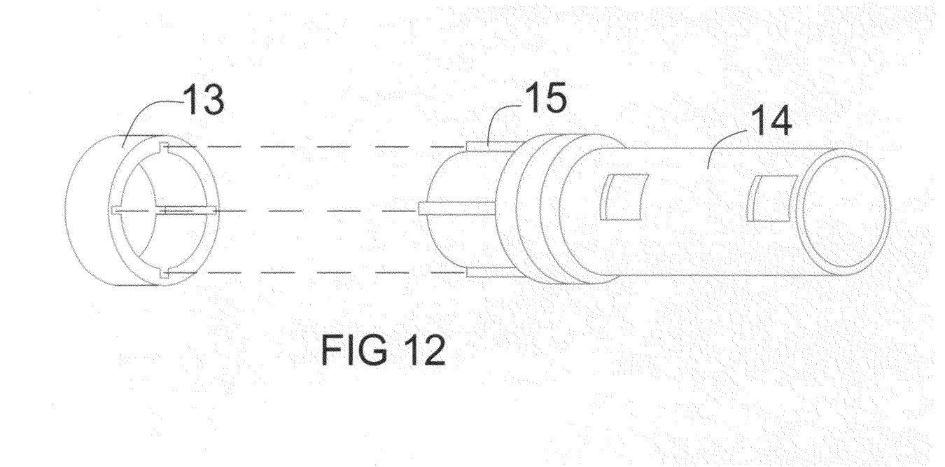

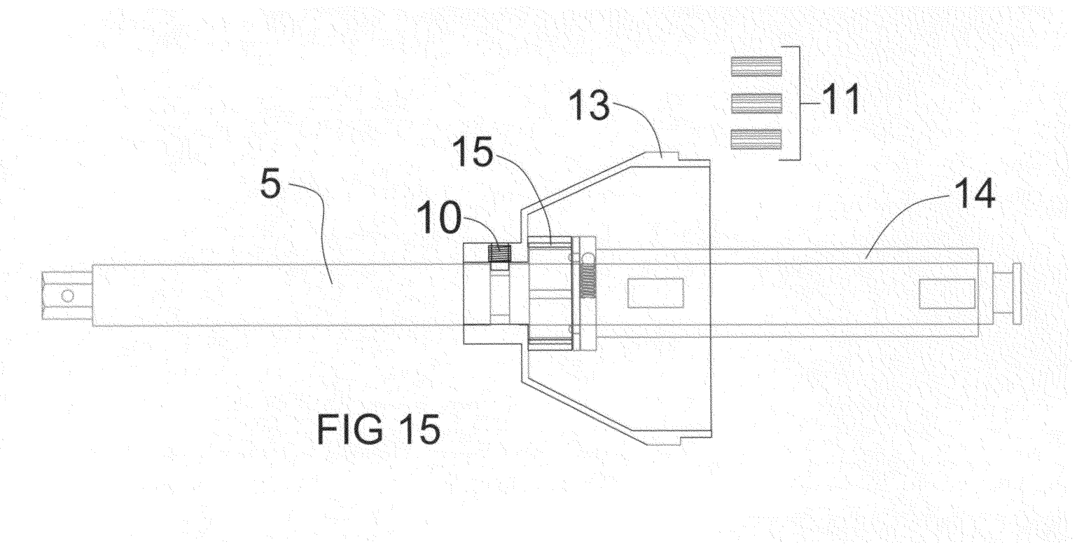

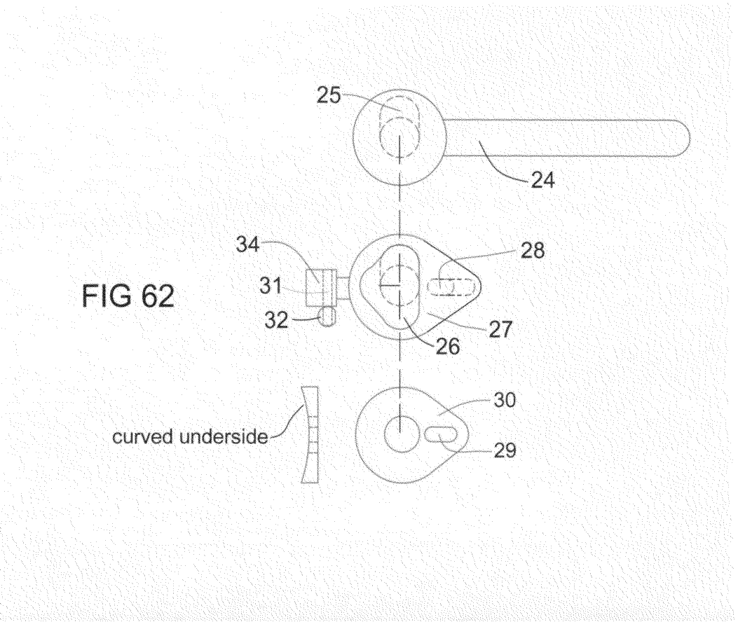

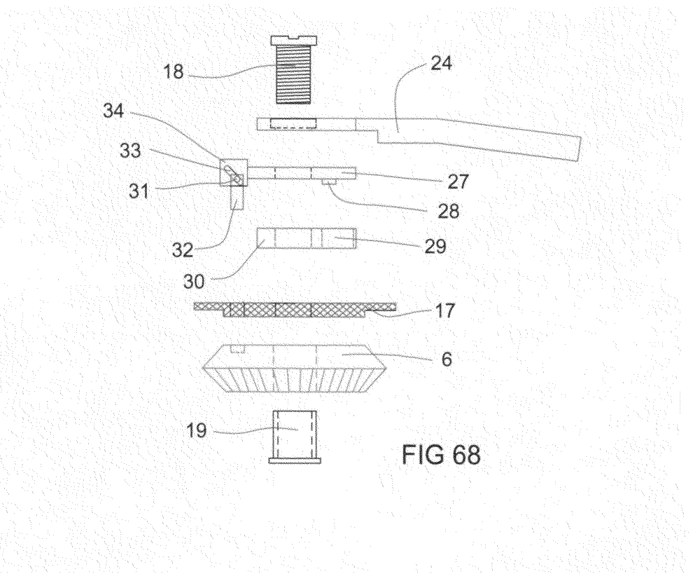

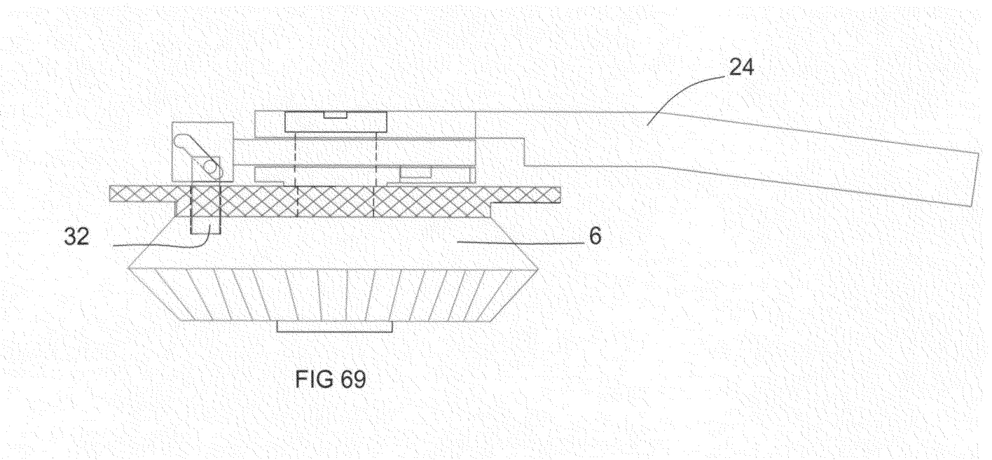

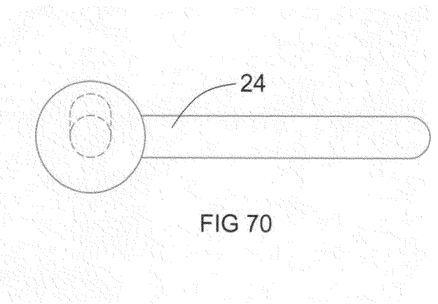

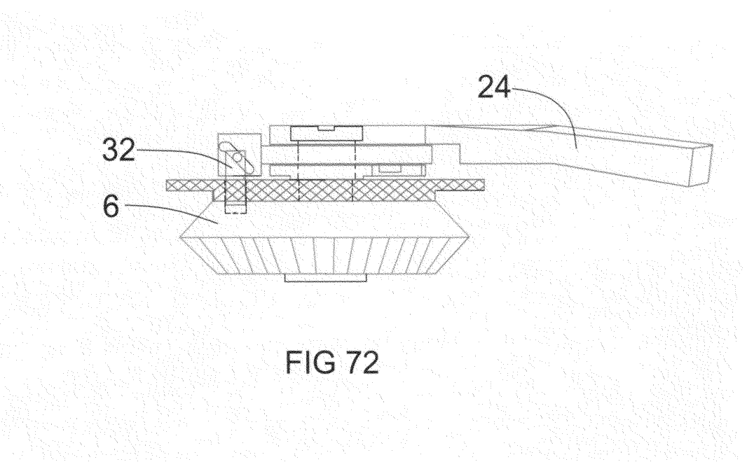

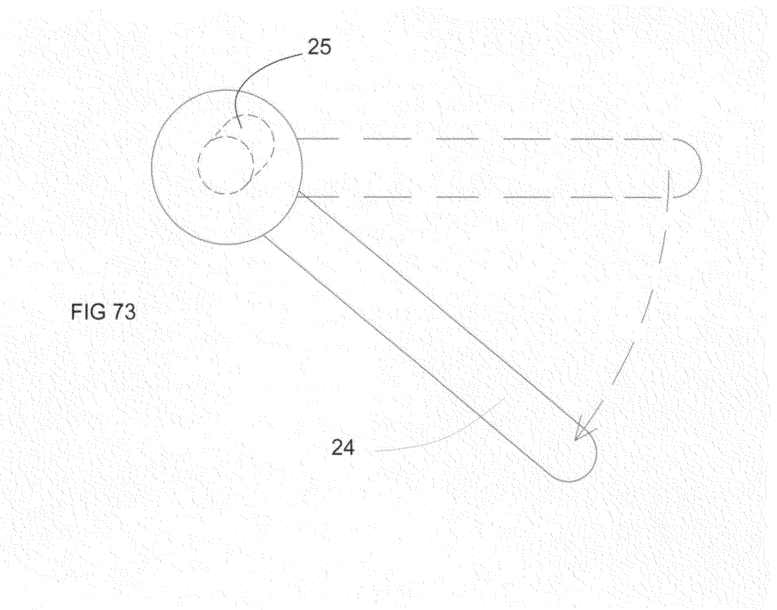

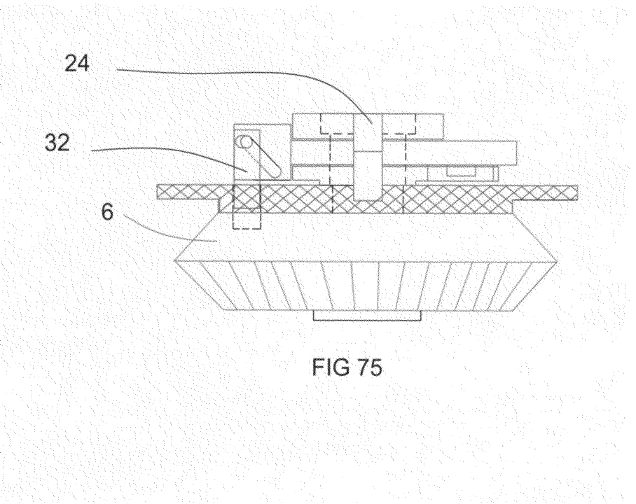

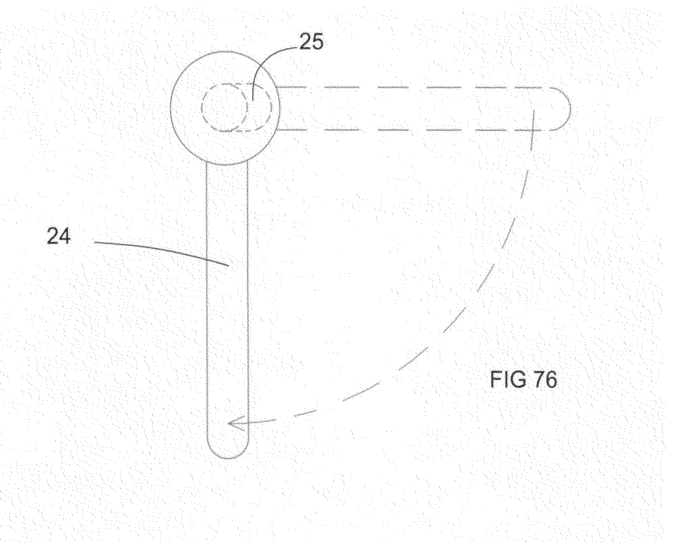

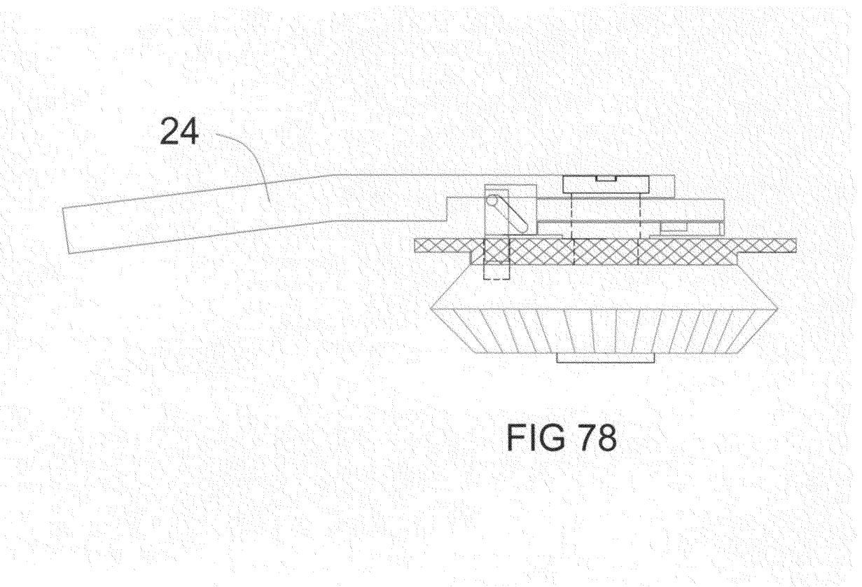

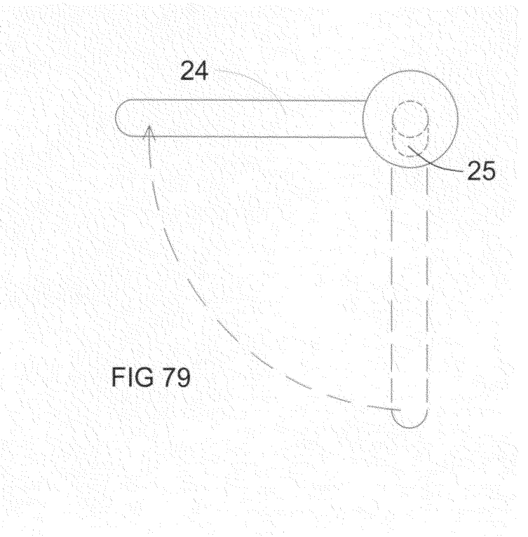

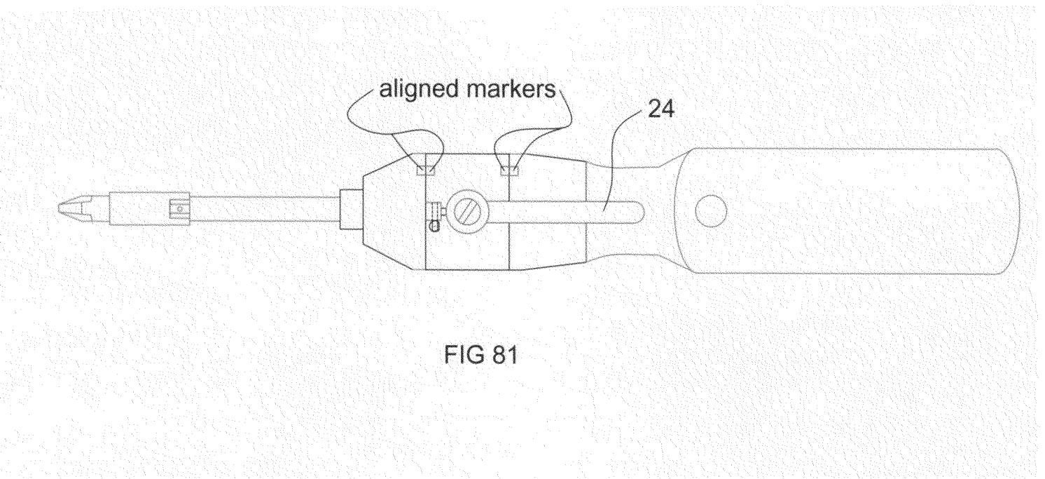

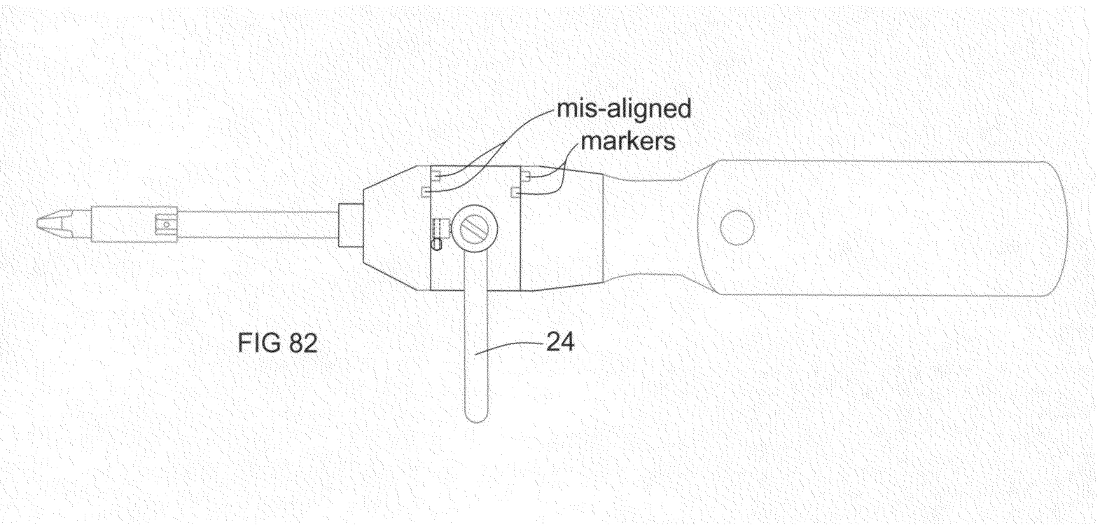

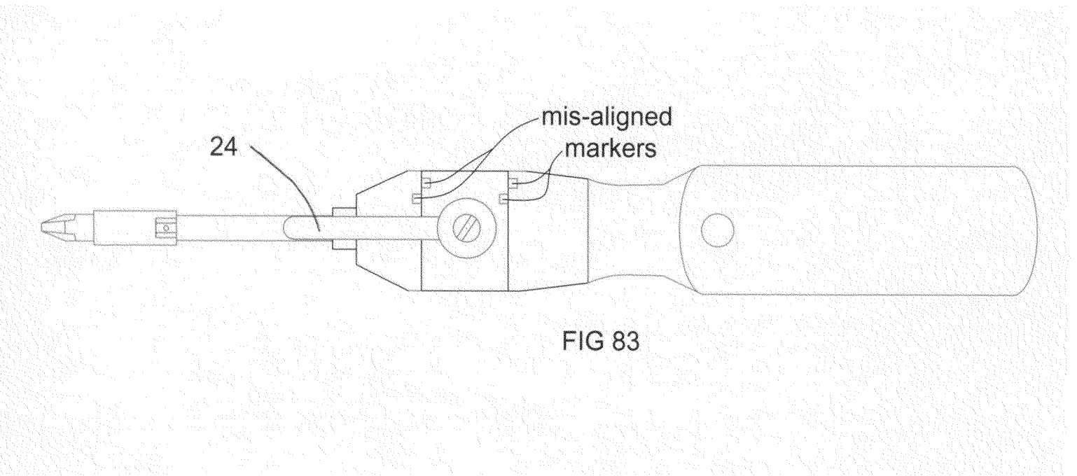

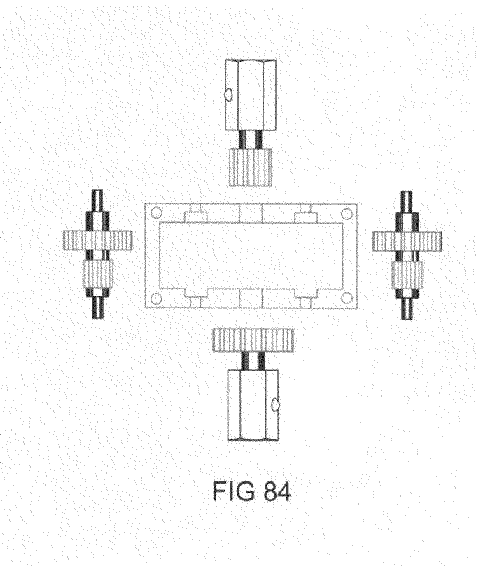

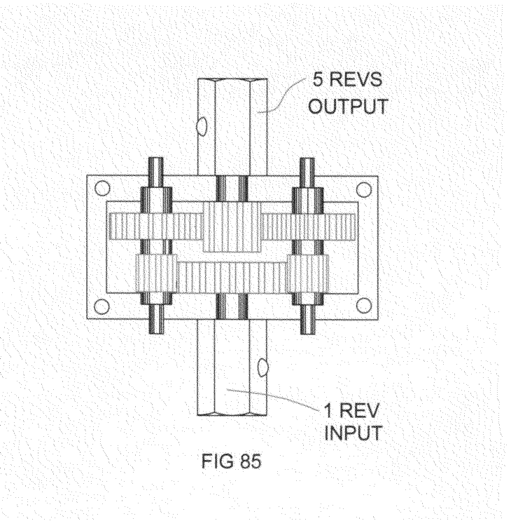

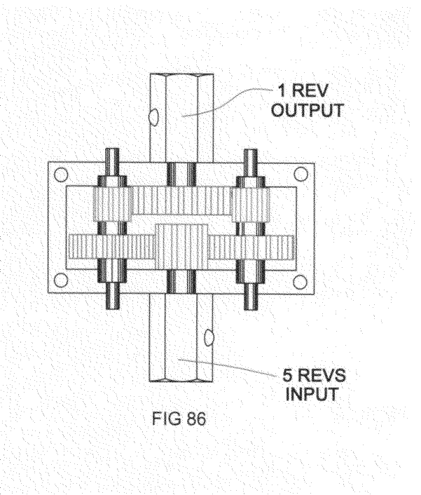

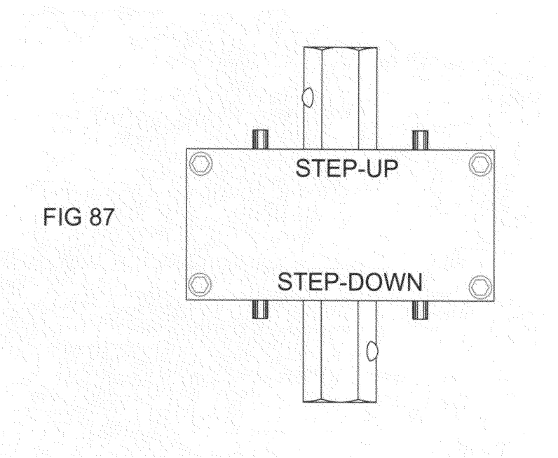

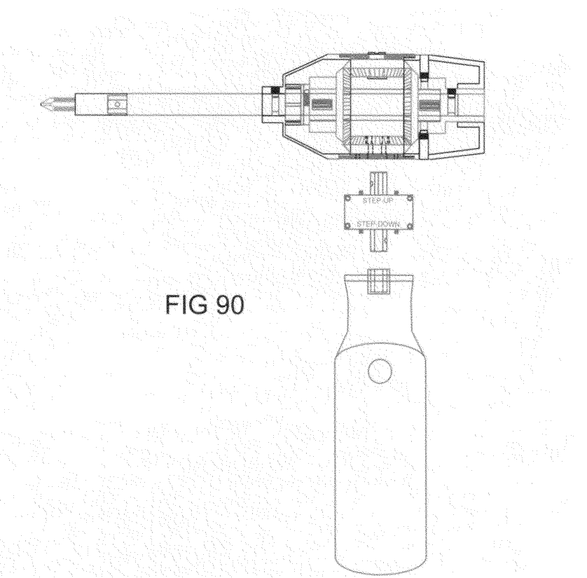

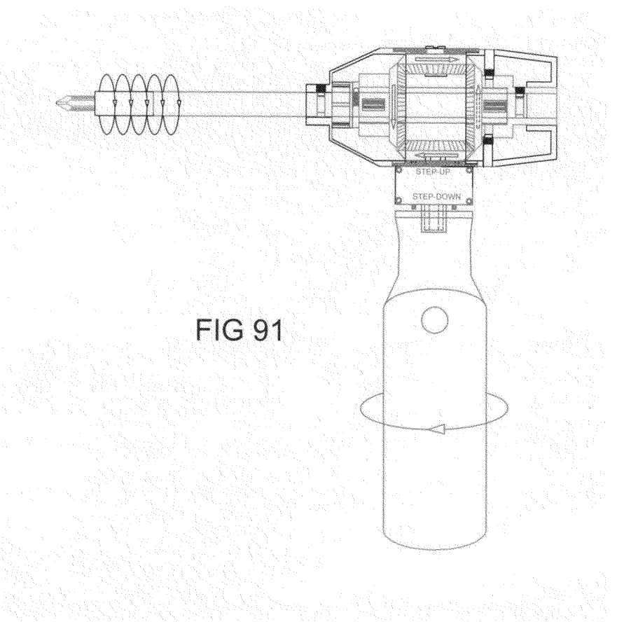

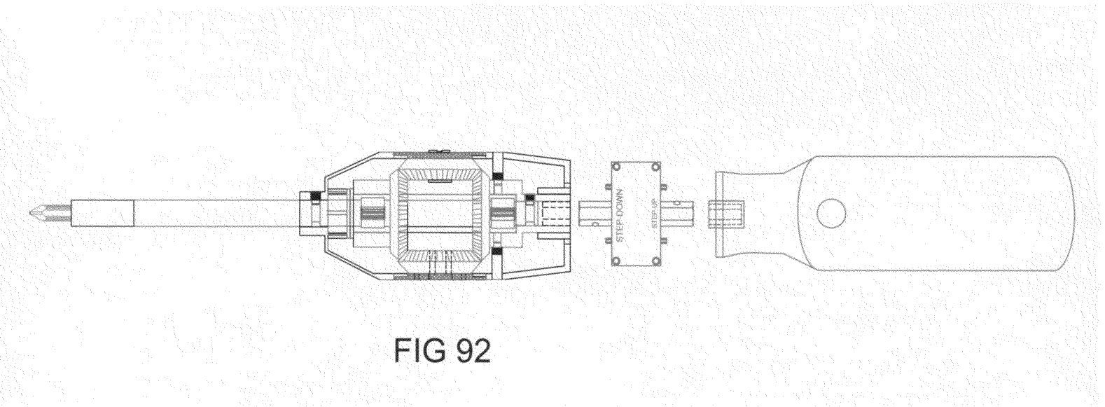

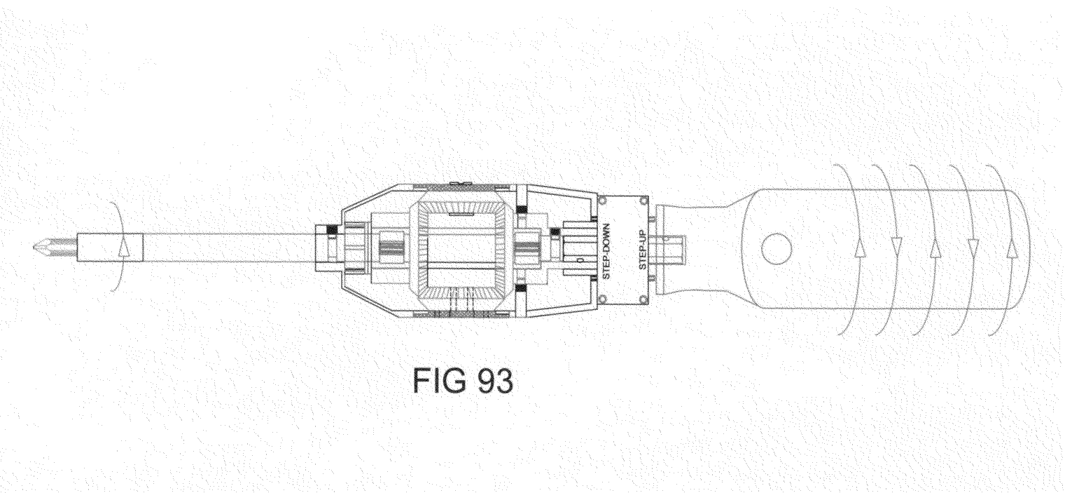

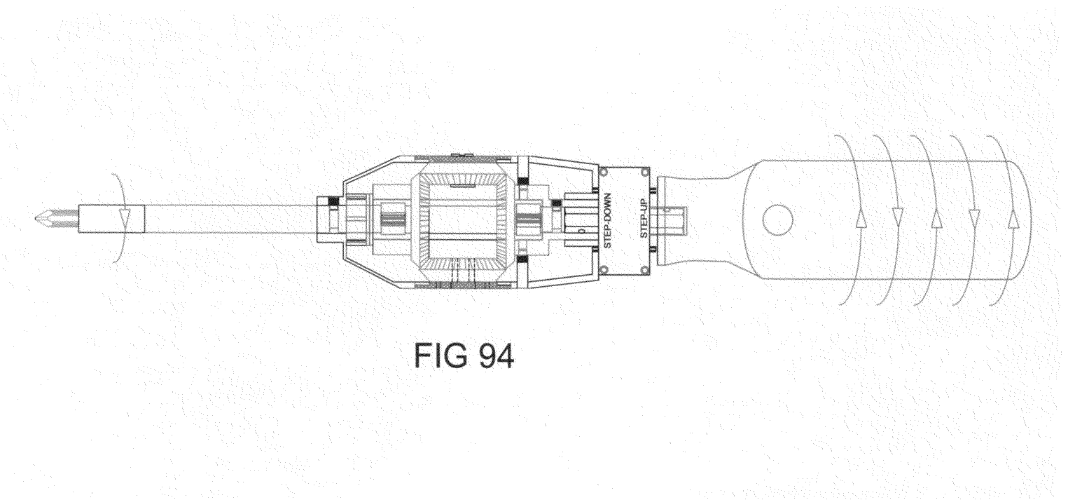

4. The drive mechanism of claim 3 wherein;
the driveshaft includes a socket at one of its extremities for receiving and driving tool bits;
the Driving Elements, are gears arranged in tandem on the driveshaft;
a Housing 17 encloses said Driving Elements and is disposed between the Posterior Housing 13 and Anterior Housing 20A;
the device coupled to each drive element for engaging the drive shaft, are mechanisms having the capability of selectively engaging the drive shaft, for imparting axial rotation in either direction, operable in forward, reverse and standard modes and disengaging, for overriding the drive shaft, from an oscillatory input motion, such as, but not limited to, ratchet wheels and pawls, two-way roller-type clutches and one-way roller-type clutches;
a gear is coaxially fitted to one end of each driving element, with said gears facing each other;
the Reversing Element is at least a third gear and an optional fourth gear, rotatable about an axle and disposed perpendicularly for meshing simultaneously with the gears that face each other, to cause their opposite rotation about the drive shaft in either direction;
a switching means, such as, but not limited to, a dial, rotatable in clockwise and counterclockwise direction, disposed coaxial with driveshaft, as proposed in FIG. 14, to change the direction of axial rotation of driveshaft, from clockwise to counterclockwise, counterclockwise to clockwise and standard non-ratcheting drive;
a locking means, such as, but not limited to, a spring-loaded ball plunger as proposed in FIG. 10 and FIG. 11, that becomes captured and retained either into a first detent for retaining driveshaft in clockwise axial rotation, or into a second detent for retaining driveshaft in counterclockwise axial rotation;
an anti-rotation means, such as, but not limited to proposed Anti-Rotation Post 32 of FIGS. 62, 68, 69, 72, 75 and 78 for being caused to become inserted into an opening provided in the hub-side of Rotatable Member of Reversing Mechanism, to lock the Rotatable Member of Reversing Mechanism into non-rotational mode, to enable the device to be utilized in a standard direct-drive 0 mode, then, caused to become fully removed from said opening of Rotatable Member of Reversing Mechanism, to enable device to be utilized in dual-drive self-ratcheting mode;
a convenient ergonomic leveraging means, to hold the Reversing Element Housing stationary, in lieu of the user needing to hold the Reversing Mechanism Housing 17 stationary, directly by hand, while user applies oscillatory motion to the Detachable Adjustable-Angle Handle 1, thereby activating the dual-drive mechanism, in lieu of the user needing to hold the Reversing Mechanism Housing 17 stationary, directly by hand, such as, but not limited to proposed Pivoting Stabilizer Lever 24 of FIGS. 62, 68, 69, 70, 72, 73, 76, 78, 79, 81, 82 and 83.
a marking means on the outside surface of device, such as, but, not limited to the one, proposed in FIGS. 81, 82 and 83 for visually assisting user to align the opening provided in hub-side of a reversing element of Reversing Mechanism, with the Anti-Rotation Post 32, in order to enable Anti-Rotation Post 32 to be inserted into opening in Reversing Element, thereby preventing rotation of Reversing Mechanism; and
an activatable attachment, comprising a step-up and step-down gear-train transmission, such as, but not limited to, the one proposed in FIGS. 84, 85, 86 and 87, to increase the ratio of input to output rotation, for expediting the installation of threaded hardware and invertible, for decreasing the ratio of input to output rotation for higher torque requirements and for being coupled to said first input port as proposed in FIGS. 92, 93 and 94 and for being coupled to said second input port as proposed in FIGS. 90 and 91.
